(19) United States
(12) Patent Application Publication
(10) Pub. No.: US 2019/0066089 A1
(43) Pub. Date: Feb. 28, 2019

(54) SECURE TRANSACTIONS USING DIGITAL BARCODES

(71) Applicant: MasterCard International Incorporated, Purchase, NY (US)

(72) Inventors: Sunitha Miryala, Singapore (SG); Sadiq Iqbal Mohammed, Alpharetta, GA (US); Ilgin Safak, White Plains, NY (US)

(21) Appl. No.: 15/686,432

(22) Filed: Aug. 25, 2017

(51) Int. Cl. G06Q 20/32; G06Q 20/36

(52) U.S. Cl. CPC G06Q 20/3274; G06Q 20/3674

(57) ABSTRACT

Methods, systems and apparatus for conducting secure transactions using digital barcodes. In an embodiment, a consumer mobile device launches a mobile payment application and then receives selection of a payment card account and an instruction to pay via a digital barcode by a cardholder. The consumer mobile device then generates at least one of a dynamic quick response (QR) code and a barcode, displays the QR code and/or the barcode on a display component, receives a purchase transaction confirmation request including merchant identification data and a transaction amount, and displays a confirmation notification for approval by the cardholder. After receiving a confirmation response, the consumer mobile device transmits the confirmation response to a digital enablement system (DES) computer. In some implementations, after transaction authorization, the consumer mobile device may receive and display a transaction completed confirmation message.

### FIELD OF THE DISCLOSURE

Embodiments described herein generally relate to processes and systems for conducting secure transactions by using digital barcodes. More particularly, disclosed are systems and processes for utilizing user-generated or merchant-generated one-dimensional barcodes or two-dimensional barcodes (QR codes) for chip card, magnetic stripe, and digital secure remote payment (DSRP) transactions with EMV-grade security.

### BACKGROUND

Portable electronic devices, such as smartphones, tablet computers, digital music players and the like, have been developed that include desirable functionality and thus the number of mobile device users and/or owners keeps growing. Such mobile devices can store all types of information, and can perform many different types of functions for users. The overall popularity of such mobile devices, especially smartphones, has led to the development of processes for using them to conduct financial transactions, for example, transmission of a payment between a payer (a consumer or payment card account holder or cardholder) and a recipient (or payee, such as a merchant or another cardholder).

A significant concern of payment systems is the protection of primary account numbers (PANs) (typically a sixteen-digit number) associated with financial accounts of consumers and of merchants from access by vandals or other wrongdoers. Thus, an important initiative for preventing the unauthorized access to PANs involves the use of “tokenization,” to transform a PAN into a token for use in the payment process. Thus, tokens have been defined as “surrogate/alternate values that replace PANs” in part of a payment system. For example, a typical consumer credit card includes the cardholder's name, a sixteen-digit personal account number (PAN), an expiration date and a security code, and any or all of this data can be “tokenized.” Tokenized data typically includes, but is not limited to, a token PAN, session keys or cryptographic keys that can be used a single time, or for a limited time, during a transaction. Once the tokenized card credentials are delivered into the consumer's device or wallet, the consumer can then use them to make a tokenized transaction at a merchant. Typically, the consumer either taps the contactless terminal with the mobile device that has a mobile payment application containing tokenized credentials to make an in store transaction, or uses a mobile payment application or web wallet to make an in app or online transaction using tokenized credentials. The token PAN, which typically has the same format as the PAN and is associated with the cardholder's sixteen-digit account number, is used to complete the purchase. The token is generated and managed by a token service provider (TSP), which de-tokenizes the token to obtain the PAN for use in processing the purchase transaction. Such processing improves the payment security of the transaction, since only the TSP, payment network and Issuer/Issuer processor see the actual PAN; the merchant and acquirer only see the token PAN.

With regard to payment card account transactions, it is also known to perform velocity checks in order to prevent fraud. A common trait of Card Not Present (CNP) fraud is a fraudster or thief using a stolen payment card account number to conduct one fraudulent transaction to see if the payment card will work, and then quickly maxing out the credit limit of that payment card account if the first transaction was accepted by engaging in multiple subsequent transactions in a short time period. Such fraud can result in chargebacks and lost revenue for issuer financial institutions and/or merchants. Thus, velocity checks entail monitoring the number of times a specific data element occurs within a specified interval. Typical data elements used for velocity checks of a transaction include, but are not limited to, the User ID, the IP address, e-mail address, phone number, device ID and/or device signature, credit card number and/or payment method, billing address, and shipping address. In some implementations, a velocity check is made up of three or more variables, but typically always includes the quantity, data element, and timeframe of a transaction or transactions. Examples of velocity checks include:
How many transactions has a customer completed in the last 24 hours?
How much has a customer spent in the last 24 hours?
How many transactions have originated from a single device in the last 24 hours?
How many orders have been placed with the same credit card number, but differing shipping addresses in the last 24 hours?
How many transactions have originated from one IP address in the last 24 hours?
How many billing zip codes has a customer loyalty card been used in within the last 30 days?
   Therefore, if certain or specified customer data is entered into a payment gateway multiple times within a designated time period, the payment gateway may take several actions to prevent fraud, such as rejecting the purchase transaction(s), notifying the cardholder of the transaction(s) to seek confirmation or repudiation, and/or notifying the merchant.

Processes are also known wherein a payer utilizes a digital camera component of his or her mobile device to scan a code, such as a barcode (1D code), or a quick-response (QR) code (2D barcode), for example, at a merchant store to initiate a purchase transaction. Barcodes (1D barcodes and QR codes) are machine-readable codes, wherein typically a 1D barcode consists of lines of varying thickness to convey information, and a QR code consists of an array of black and white squares. QR codes are typically used for storing uniform resource locators (URLs) or other information that can be read by a camera component of a consumer's mobile device, such as a smartphone. For example, a retailer may have a sticker or label or sheet of paper having a merchant QR code printed thereon affixed to a countertop near a cash register (or on the cash register) at the merchant's retail store. In some embodiments, the label or sticker having the merchant QR code printed on it may be provided to the merchant by a payment processing company (or by some other trusted third party), and can include merchant identification data and a merchant payment account number (associated with a financial account of the merchant). In some implementations, the consumer utilizes a mobile payment application and the camera component of his or her mobile device to scan a merchant QR code, then inputs a purchase transaction amount (the cost or price of the goods or services) and transmits a payment request so that funds can be transferred from the consumer's payment card account to the merchant's payment account (which may be processed by a payments system such as the Mastercard MoneySend™ or Mastercard Send™ platforms). For such processing to be successful, both the merchant and the customer must be registered with a payments platform that accepts QR code transactions. However, such systems are susceptible to “man in the middle” and/or replay attacks, wherein a hacker or other vandal intercepts and/or re-directs the payment before it reaches the merchant payment account, or reuses the same credentials to make a duplicate payment.

Mastercard International Incorporated, the assignee of the present application, has developed the “Mastercard Digital Enablement Service” (MDES) platform, which provides a suite of on-behalf-of (OBO) services that support the management, generation, provisioning and utilization of digital payment credentials (such as tokens) into and/or using mobile devices. For example, the MDES platform generates and manages tokens, and can provide an EMV-like version of the merchant's account number. (“EMV” stands for Europay, Mastercard, Visa, and denotes a global standard for chip-based debit card account and credit card account transactions that ensures security and global acceptance of such accounts.) Thus, a user of the MDES platform may engage in digital transactions that include cryptograms, dynamic data and the like for added security. The MDES platform therefore enables simpler, more secure digital payment experiences than those offered in the past, and has been developed to facilitate the financial industry transition from consumer account credentials stored on traditional payment cards, to digital credentials provisioned into mobile devices. Digitized credentials enable the consumer's mobile device to perform payments via existing contactless point-of-sale systems and via new remote payment use cases, such as by utilizing in-app or online payments. Such digitization service-enhanced, device-based payment methods are designed to offer consumers simpler checkout and payment experiences, and to provide increased payment security.

Masterpass™ is a global digital payments service offered by Mastercard International Incorporated that enables consumers to look no further than their own trusted bank to make fast, seamless and secure digital payments across devices and channels anywhere they want to shop. Masterpass™ can be used as a companion payment application to a mobile banking app, as a separate bank-branded payment app using the Masterpass™ payment capabilities, or can be embedded within the mobile banking app. In addition, there are other Masterpass™ supported wallets including Masterpass by Mastercard (direct wallet), and DACs supporting Masterpass™ (X-Pay wallets, such as Apple Pay™, Samsung Pay™, and Android Pay™). Thus, consumers can shop online, in app and with a contactless tap at millions of locations around the world by using their mobile devices, as Masterpass™ is designed to support and integrate into any smart device across operating systems and manufacturers. Masterpass™ utilizes a combination of bank verification, card tokenization and EMV-like capability to deliver greater security across payment channels.

Masterpass™ can work together with the MDES platform to enable the tokenization and digitization of payment cards in Masterpass™ and other digital payment applications. In addition, an issuer financial institution can implement MCBP (Mastercard Cloud-Based Payments) to enable secure cloud-based contactless and in-app payments (with or without MDES as a trusted service provider (TSP); the issuer or a third party may act as an MCBP TSP independent of MDES). The implementation of Masterpass™ payment APIs enables a bank wallet to connect to the Masterpass™ online acceptance network. Issuer FIs can also develop payment applications with the Masterpass Mobile Checkout SDK to embed Masterpass into the issuer's native app or develop a companion payment app.

Masterpass™ also provides a way for merchants to deliver a convenient shopping experience to their customers while also securing all channels of commerce. Since Masterpass™ is backed by banks worldwide, merchants can gain access to mainstream consumers who trust banks over other companies (such as Google, Apple and/or PayPal) and provide them with a digital payment solution. Merchants who wish to integrate with and accept Masterpass™ digital payments first need to determine the channels for Masterpass™ acceptance (online, in-app and/or in-store), and then integrate with available Masterpass™ merchant application programming interfaces (APIs) and software development kits (SDKs) to enable Masterpass™ checkout online and in the merchant's mobile app. Merchants must also enable contactless processing at the point of sale (POS) terminal to accept Masterpass™ in-store for contactless (HCE) payment. The merchant and/or the merchant's acquirer FI also needs to integrate their backend systems and merchant website and/or mobile app with the Masterpass™ switch to accept Masterpass™ digital secure remote payments (DSRP).

In the current retail environment, consumers want to be able to make digital payments using their mobile devices at their own convenience, and merchants wish to increase their footprint in the marketplace by accepting digital payments. However, conventional digital payment systems require the merchant to purchase expensive, contactless point-of-sale (POS) terminals, which can present a significant obstacle for some brick-and-mortar merchants. Although barcode scanning processes currently exist that permit a cardholder to make digital payments, some are prone to hacking, and no mechanisms exist that permit the use of barcode payments, including 1D or QR code payments, with EMV-grade security. Thus, a need exists for barcode payment methods and systems that are easy and inexpensive to use and implement, and that provide EMV-grade security.

### BRIEF DESCRIPTION OF THE DRAWINGS

Features and advantages of some embodiments of the present disclosure, and the way such embodiments are accomplished, will become more readily apparent upon consideration of the following detailed description taken in conjunction with the accompanying drawings, which illustrate exemplary implementations and are not necessarily drawn to scale, wherein:

FIG. 1 is a block diagram illustrating components of a digital barcode wallet system for providing secure payment transactions utilizing one-dimensional and two-dimensional digital codes in accordance with embodiments of the disclosure;

FIG. 2 is a block diagram of a barcode (1D barcode and/or QR code) transaction and purchase authorization system for illustrating processes in accordance with embodiments of the disclosure;

FIG. 3A is a flow diagram illustrating a consumer generated barcode (1D digital barcode and/or QR code) process in accordance with some embodiments of the disclosure;

FIG. 3B is a flowchart illustrating a consumer generated barcode (1D digital barcode and/or QR code) process in accordance with some embodiments of the disclosure;

FIGS. 4A-4H illustrate examples of screen displays (or screen shots) of mobile device user interface screens associated with a smart card purchase transaction featuring a consumer generated barcode process in accordance with some embodiments of the disclosure;

FIGS. 5A-5G illustrate examples of screen displays (or screen shots) of mobile device user interface screens associated with a smart card purchase transaction featuring another consumer generated barcode process in accordance with some embodiments of the disclosure;

FIGS. 6A-6H illustrate examples of screen displays (or screen shots) of mobile device user interface screens associated with a digital secure remote payment (DSRP) transaction featuring a consumer generated barcode (1D digital barcode and/or QR code) process in accordance with some embodiments of the disclosure;

FIGS. 7A-7H illustrate examples of screen displays (or screen shots) of mobile device user interface screens associated with a digital secure remote payment (DSRP) transaction featuring a consumer generated barcode (1D digital barcode and/or QR code) process in accordance with some embodiments of the disclosure;

FIGS. 8A-8G illustrate examples of screen displays (or screen shots) of mobile device user interface screens associated with a purchase transaction featuring a consumer generated barcode (1D digital barcode and/or QR code) process utilizing a web wallet in accordance with some embodiments of the disclosure;

FIGS. 9A-9G illustrate examples of screen displays (or screen shots) of mobile device user interface screens associated with another digital secure remote payment (DSRP) transaction featuring a consumer generated barcode (1D digital barcode and/or QR code) process utilizing a web wallet in accordance with some embodiments of the disclosure;

FIGS. 10A-10G illustrate examples of screen displays (or screen shots) of mobile device user interface screens associated with a digital secure remote payment (DSRP) transaction featuring another consumer generated barcode (1D digital barcode and/or QR code) process in accordance with some embodiments of the disclosure;

FIGS. 11A-11G illustrate examples of screen displays (or screen shots) of mobile device user interface screens associated with another digital secure remote payment (DSRP) transaction featuring a consumer generated one-dimensional barcode process utilizing a web wallet in accordance with some embodiments of the disclosure;

FIG. 12A is a flow diagram illustrating a merchant generated QR code process in accordance with some embodiments of the disclosure;

FIG. 12B is a flowchart illustrating a merchant generated QR code process in accordance with some embodiments of the disclosure;

FIGS. 13A-13F illustrate examples of screen displays (or screen shots) of mobile wallet application user interface (UI) screens associated with a digital secure remote payment (DSRP) transaction featuring a merchant generated dynamic QR code process in accordance with some embodiments of the disclosure; and

FIGS. 14A-14G illustrate examples of screen displays (or screen shots) of mobile device user interface screens associated with a digital secure remote payment (DSRP) transaction featuring a merchant generated static QR code process in accordance with some embodiments of the disclosure.

### DETAILED DESCRIPTION

Reference will now be made in detail to various novel embodiments, examples of which are illustrated in the accompanying drawings. It should be understood that the drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of these embodiments may be practiced without some or all of the specific details. In other instances, well-known process operations have not been described in detail in order not to unnecessarily obscure novel aspects.

A number of terms will be used herein. The use of such terms is not intended to be limiting, but rather are used for convenience and ease of exposition. For example, as used herein, the term “user” may be used interchangeably with the term “consumer” and/or “cardholder” and are used herein to refer to a consumer, person, individual, business or other entity that owns (or is authorized to use) a financial account such as a payment card account (for example, a credit card account). In addition, the term “payment card account” may include a credit card account, a debit card account, and/or a deposit account or other type of financial account that an account holder may access. The term “payment card account number” includes a number that identifies a payment card system account or a number carried by a payment card, and/or a number that is used to route a transaction in a payment system that handles debit card and/or credit card transactions and the like. Moreover, as used herein the terms “payment card system” and/or “payment network” refer to a system and/or network for processing and/or handling purchase transactions and related transactions, which may be operated by a payment card system operator such as Mastercard International Incorporated, or a similar system. In some embodiments, the term “payment card system” may be limited to systems in which member financial institutions (such as banks) issue payment card accounts to individuals, businesses and/or other entities or organizations. In addition, the term “mobile payment application” (MPA) is used interchangeably herein with the term “mobile wallet application.” Additionally, the term “wallet” is used herein interchangeably with the term “digital wallet”, wherein “wallet” may refer to the client (front-end) side or may refer to the entirety of the wallet solution, including the back-end system(s).

In general, and for the purposes of introducing concepts of novel embodiments described herein, described are systems and processes that provide a standard digital barcode (1D barcode and/or QR code) wallet solution for securely performing in-store and online (chip card, magnetic stripe (or magstripe) and Digital Secure Remote Payment (DSRP)) purchase transactions. In particular, systems and processes disclosed herein involve generating cryptograms for EMV-like secure digital payments utilizing one-dimensional (1D) barcodes or two-dimensional (2D) barcodes. Using barcodes to securely conduct financial transactions as disclosed benefits both consumers and merchants because barcodes are versatile, are easy to use, and can be generated on, and scanned by, any type of mobile device having a digital camera. Moreover, use of the disclosed techniques by merchants can help them save money because those merchants are not forced to purchase and use expensive contactless POS terminals in order to enjoy the benefits (such as customer stickiness and increase of sales revenues) of accepting digital payments. Additionally, for merchants already accepting digital payments (in store or online) via processes that do not use tokenization, the additional layer of security introduced by use of tokenization will help them to reduce costs by reducing chargebacks due to fraudulent transactions. In addition, usage of dynamic cryptograms that incorporate a channel indicator (i.e., point of sale (POS) and or eCommerce), a random number (nonce) and cardholder verification data prevents replay attacks, cloning attacks and cross channel attacks. This implies that an attacker cannot use the same cryptogram a second time, on a different channel, or on a different device.

In practical systems in accordance with embodiments described herein, multiple merchants and multiple issuers are operably connected to the digital wallet barcode solution system. Adoption of the disclosed techniques allows only registered merchants to accept payments, and therefore eliminates the redirection of funds to fraudulent merchants, which beneficially reduces money laundering and loss of finances to consumers. In addition, only those consumers that authenticate themselves against an issuer financial institution (FI) or a trusted third party have access to a digital barcode wallet, which eliminates unauthorized access to consumer accounts. Thus, the disclosed solution is valid for any kind of digital wallet that would support Masterpass™, including an issuer FI, DAC (Apple Pay, and the like), and Masterpass™ direct (Masterpass™ by Mastercard). Yet further, the disclosed techniques require consumers to consent to a payment transaction by confirming the transaction amount and requiring entry of a customer verification method (CVM) for a Card Present transaction. Providing such consent prevents a merchant from withdrawing an amount the consumer has not approved of, thereby reducing chargebacks.

In accordance with disclosed embodiments, application cryptograms (including mobile device (MD) and user-mobile device (UMD) cryptograms) are generated and used for smart card (or chip card, such as M/Chip™ card) transactions, for magnetic stripe (Magstripe or mag stripe) payment card transactions, and for Digital Secure Remote Payment (DSRP) transactions (such as online transactions occurring over the Internet utilizing a cloud-based system) with a digital wallet. For example, a cryptogram may be generated either by a mobile payment application for chip card transactions with a quick-response (QR) code (which is an example of a 2D barcode), or may be generated in the cloud for DSRP transactions with a one-dimensional (1D) barcode on legacy systems. In some embodiments described herein, transactions are initiated by a consumer, and thus the consumer generates a 1D barcode and/or a 2D barcode by using a mobile wallet application or a web wallet (such as a Masterpass™ wallet) on his or her device, which can be used to make chip card (i.e., M/Chip) or DSRP payments. The merchant then reads the barcode (either a 1D or 2D barcode (QR code)) with either a camera component of a merchant mobile device (such as a digital camera of an Android™ smartphone or an iPhone™) or with a scanner (a barcode scanner or a QR code scanner, which may be associated with a point of sale (POS) device). In some implementations, the consumer is then prompted to enter data satisfying a cardholder verification method (CVM) prior to completing the transaction (for example, by entering a mobile personal identification number (mPIN), by authenticating themselves against the device (device level authentication), or by providing biometric data such as a fingerprint, or the like) by using one or more components (such as a touch screen and/or a digital camera and/or a fingerprint scanner) associated with his or her mobile device. If all is in order, then processing proceeds to complete the transaction.

In some other disclosed embodiments, a merchant generates a QR code when a purchase transaction is initiated, for example, by using a merchant application (which is integrated with Masterpass™ merchant SDK and the merchant systems) at the point of interaction (POI). The POI may, for example, be a point-of-sale (POS) terminal or a mobile device. In such implementations, the consumer then utilizes a camera associated with his or her device to read the merchant-generated QR code, and then the consumer is prompted to enter authentication data to satisfy a cardholder verification method (CVM) (for example, by entering a mobile personal identification number (mPIN), by authenticating themselves against the device (device level authentication or DLA), or by providing biometric data) using one or more consumer mobile device components (such as a touch screen and/or a digital camera and/or a fingerprint scanner). If all is in order, then processing may proceed in a known manner to complete the transaction.

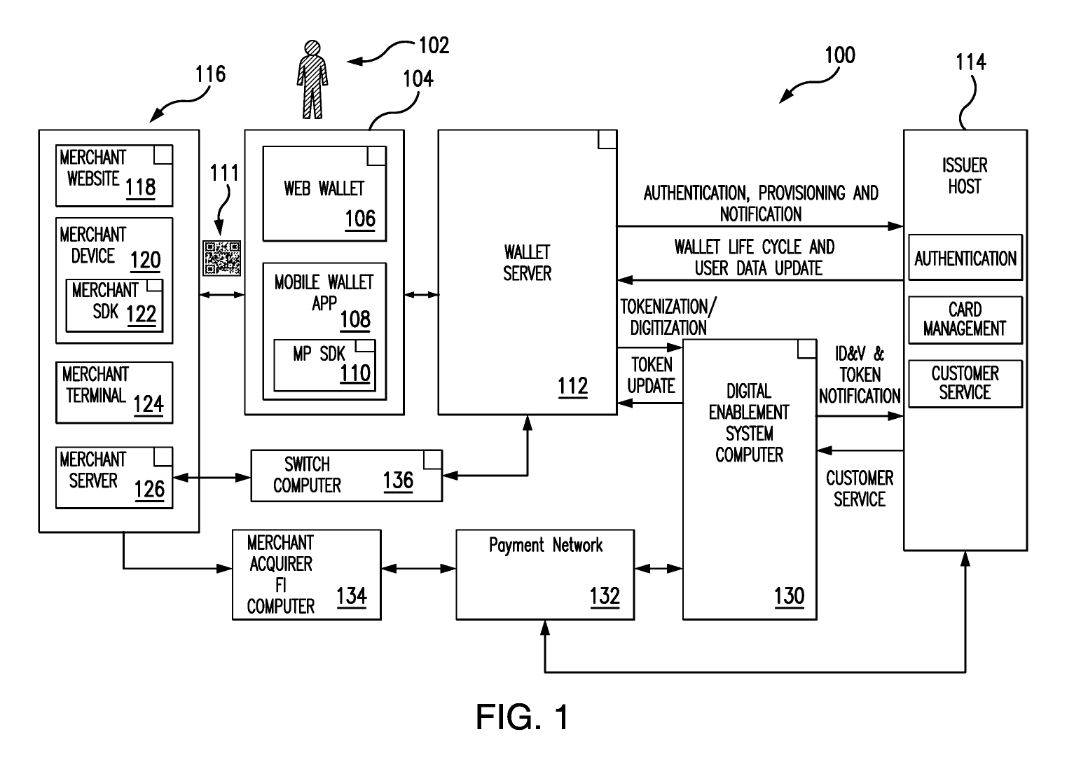

FIG. 1 is a block diagram illustrating a digital barcode wallet system 100 in which teachings of the present disclosure may be applied. An individual user and/or cardholder or consumer is indicated by reference numeral 102 in FIG. 1. Many of the users 102 habitually carry with them mobile devices 104, such as smartphones, tablet computers, or the like, which are configured for entering into mobile payment transactions. The consumer's mobile device 104 (such as an iPhone™ or Android™ device) typically includes components such as a microphone, speaker, touchscreen, digital camera and/or a biometric sensor (such as a fingerprint scanner, not shown). In some embodiments, the mobile device 104 includes a web wallet application 106 and/or a mobile wallet application 108 which may include a software development kit (SDK) 110. The SDK 110 is used to facilitate communications between the digital wallet and the wallet service provider and/or issuer FI and/or token service provider, as well as for performing payment card, transaction, fraud and digital wallet management functions, and the like. In some implementations, the consumer's mobile device 104 includes software instructions (such as a mobile wallet application 108) configured to generate a digital barcode (1D barcode and/or QR code) 111 for use in purchase transactions. For example, the mobile wallet application 108 may be configured for generating the digital barcode (1D barcode and/or QR code) 111 on a display screen (not shown) which is then read by a camera component or a (1D or 2D) barcode scanner (not shown) associated with the merchant device 120. The merchant device (POS terminal or mobile device) 120 then submits the received data to, for example, the merchant server and/or system, when then submits the transaction request to the merchant acquirer financial institution (FI) server or computer 134 for forwarding to a payment network 132 for further transaction processing with relation to payment for goods and/or services, which will be further explained below.

Referring again to FIG. 1, the mobile device 104 is configured for communications with a wallet server/computer 112 (which may be owned and/or operated by an issuer FI, or an entity such as a Wallet Service Provider (WSP), or a payment processing entity such as Mastercard International Incorporated, the assignee of the present application). In some implementations, the communications between the user's mobile device 104 and the wallet server 112 may occur through use of a private network or a public network and/or combinations thereof, for example, by using the Internet (not shown in FIG. 1). As shown, the wallet server 112 is in turn configured for communications with an issuer financial institution (FI) computer 114 (which may be associated with, for example, a bank which issues payment card accounts to consumers or users). The wallet server 112 may transmit mobile device provisioning requests for tokenization and/or digitization, user and/or mobile device authentication requests, wallet and/or card management requests, and/or notification data to the issuer FI computer 114, and may receive responses to such requests and/or data. In addition, the issuer FI computer 114 may provide additional data and or information such as wallet life cycle data, card management data, and/or user data updates to the wallet server 112. The issuer FI computer may also be configured for providing card management services, authentication and/or access to a customer service representative for customer support regarding the wallet. It should be understood that, in practical digital barcode wallet systems 100 a plurality of issuer FIs may be included.

The digital barcode wallet system 100 also includes merchant components 116 that may include computer systems for providing a merchant website 118, a merchant device 120 including a merchant software development kit (SDK) 122, a merchant terminal 124 (such as a point-of-sale (POS) terminal) that may include a barcode (1D or QR) code reader or scanner (not shown), and a merchant server computer 126. In some embodiments, multiple merchant systems are connected to the wallet server 112, and the merchant SDK 122 and the Masterpass APIs would be used in integration of that particular merchant system with the switch computer 136 (e.g., the Masterpass™ switch). Each such merchant component may be in communication with one or more of the other merchant components. In some embodiments, the merchant device 120 is configured for generating a digital barcode such as the QR code 111 for use during a purchase transaction, while in other implementations, the merchant device 120 and/or merchant terminals 124 may be configured for reading a 1D barcode or QR code generated by the user's mobile device 104. The cardholder's mobile device 104 may thus be configured for communications with one or more of the merchant components 116 to conduct a purchase transaction. The user's mobile device 104 may also be configured for communicating with many types of other devices, such as other user mobile devices (not shown), for example, for exchanging audio and/or text messages and the like via a mobile network operator (“MNO”) system or the like (not shown in FIG. 1).

Referring again to FIG. 1, the digital barcode system wallet system architecture 100 includes a digital enablement service (DES) computer system 130, which functions as a trusted service provider (TSP) and may include a token vault (not shown). The DES computer system 130 is operable to provide a plurality of on-behalf-of (OBO) services, including digitization and tokenization services to requestors, which replaces payment card account numbers with tokens and places these into digital web wallet or mobile wallet environments. In accordance with a Payment Token Interoperability Standard, token requestors may include payment card account issuers (which include issuer financial institutions, such as banks), card-on-file merchants, acquirer financial institutions, original equipment manufacturer (OEM) device manufacturers and digital wallet providers. In some embodiments, each such token requestor is required to register with the DES computer system 130 before requesting use of the token service, which includes mapping tokens to card numbers during a purchase transaction in a secure manner (typically by using cryptograms). Thus, the DES computer system 130 enables connected devices to make purchases in-store, in-app and/or online (via the Internet). In addition, as a provider of tokens, the DES computer system 130 may perform such functions as operating and maintaining the token vault (which stores token data, including token requester credentials and/or payment account data associated with the tokens), generating and issuing or provisioning tokens, assuring security and proper controls, and registering token requestors.

In addition, in some embodiments, during the tokenization process the DES computer system 130 may be configured to generate and provide an EMV-like version of the user's payment card account number. (“EMV” stands for Europay, Mastercard, Visa, and denotes a global standard for chip-based debit card account and credit card account transactions that ensures security and global acceptance of such accounts.) For example, assuming a consumer generated barcode, in addition to including the consumer's token account information, a cryptogram and M/Chip and Mag stripe data may be generated and added to the transaction data for use during the purchase transaction process for added security. On the other hand, assuming a merchant generated QR code, the QR code could contain the merchant information (e.g. merchant name, merchant ID, transaction ID, nonce, indicator for DSRP support, authentication token), as well as transaction information (for example, the transaction amount, currency and a transaction timestamp) and a cryptogram generated either by the device or by the cloud (retrieved from the wallet server) would be utilized in the purchase transaction. The DES computer 130 would perform cryptogram validation and de-tokenization before the purchase transaction is authorized by the issuer 114. Once the issuer authorizes the transaction, a response is transmitted back to the payment network 132, which then sends the response to DES computer 130 for token mapping. The DES computer 130 completes token mapping and sends the authorization response and/or financial transaction in tokenized form to the payment network 132. The payment network 132 then forwards the response back to the merchant acquirer FI computer 134, which then sends it to the POS terminal 124 to complete the transaction.

Referring again to FIG. 1, the DES computer system 130 is operably connected to the wallet server 112, the issuer FI computer 114, and to a payment network 132. The payment network 132, which may be the well-known Banknet® system operated by Mastercard

International Incorporated (the assignee hereof), is operably connected to the merchant acquirer FI computer 134 and to the issuer FI computer 114. The merchant's acquirer FI computer 134 is associated with the financial institution (the merchant FI) that provides banking services to the merchant, and functions to receive and to route payment transaction authorization requests that originate from the merchant server 126 and/or merchant website 118. As mentioned earlier, in a practical digital barcode wallet system, there will be a plurality of issuer FI computers that typically represent banks or other financial institutions that provide banking services to users or consumers in addition to issuing payment accounts (for example, credit card accounts and/or debit card accounts) to the cardholders or users 102. Such a practical digital barcode wallet system will also include a plurality of consumers and their associated mobile devices, as well as a plurality of merchants and their associated merchant mobile devices, POS terminals, merchant servers, and merchant acquirer FIs. As mentioned above, the DES computer system 130 provides tokenization and/or digitization services and/or token updates to the wallet server 112, may also provide identification and verification services, customer services and notifications to the issuer FI computer 114, and may also provide tokenization, transaction history and notification services to the payment network 132.

In order to conduct digital barcode purchase transactions with a mobile wallet application, the user or cardholder 102 must first either download a digital barcode mobile wallet application to his or her mobile device 104 from an authorized party (such as a mobile application store like the Google Play™ Store, the App Store™, and the like), or enable the wallet within the issuer mobile banking application. In some implementations, however, the digital wallet may already be installed on the consumer's mobile device by default, for example, if an X-Pay wallet, and the user may need to enable Masterpass™ functionality. In order to conduct digital barcode purchase transactions with a web wallet, the cardholder 102 may be required to register online for a digital barcode web wallet (e.g., from the issuer financial institution website, issuer online banking website, or wallet service provider website).

In some implementations, when a mobile wallet application is first downloaded and initialized on the consumers' mobile device 104, or enabled within the issuer mobile banking application, or enabled on the issuer online banking website, or when registering for a web wallet for the first time, the digital barcode mobile wallet application or web wallet may prompt the user or cardholder 102 to provide consumer registration information. The consumer registration information may include information such as the cardholder's name, billing address, and the like. If a mobile wallet application is to be enabled, the cardholder may also be requested or prompted to provide a mobile/wallet PIN (personal identification number), or to set Device Level Authentication (DLA) or biometrics (e.g. fingerprint) for wallet login and/or for the purpose of making a digital barcode payment. The mobile PIN could be valid and/or the same for the entire wallet (referred to as a wallet PIN), or valid only for a single card (for one payment card account). In some implementations, the mobile wallet application may have a one PIN for login (mobile application PIN) and a separate, different PIN (mobile PIN) for payments purposes.

In addition, the consumer may be prompted to add a payment method, such as a credit card account or debit card account. An activation code may be requested to be entered in the wallet by the cardholder in order to activate the wallet or add a payment method. The activation code could be sent by the issuer or wallet service provider via SMS, email, and the like, or the consumer may be requested to call a customer service representative (CSR) to verify that the consumer is the actual cardholder. Alternatively, the payment method and cardholder information may also be provided by the issuer after the consumer has authenticated himself or herself against the issuer (e.g., using online banking credentials), instead of requesting it from the consumer. In some embodiments, during registration the cardholder is also requested to accept terms and conditions provided by the issuer for usage of the wallet. In some embodiments, the consumer registration information and payment method (i.e., credit card account number, which may be the user's primary account number (PAN) associated with the cardholder's account) is transmitted to the DES computer system 130 for account enablement processing. Thus, in some implementations, the DES computer system 130 prepares provisioning data that is based on the cardholder registration information received from either the wallet provider computer 112 or the issuer, or both. The DES computer system 130 generates the token card profile by performing tokenization (generation of the token PAN linked to the card PAN) and digitization (preparation and delivery of token card data, including session keys/cryptographic keys, etc., for usage with the device). The DES computer system 130 transmits the token card data to the mobile device 104 for storage either in a secure element, trusted execution environment (TEE) (referred to as secure environment (SE) based tokens), or in software (referred to as cloud based device tokens) for usage by the digital barcode mobile wallet application. The token card data provisioned into software could also be stored more securely using other methods, such as white box cryptography.

Referring again to FIG. 1, a switch computer component 136 (which may be the Masterpass™ switch computer) is operably connected to the merchant server 126 and to the wallet server 112. Such a switch computer component 136 is configured for passing data between the merchant and the wallet server 112, and provides tools for use by registered financial institutions (such as banks) to build digital wallets that can be utilized by their customers (that can be used for contactless, in-app and/or mobile/web browser checkout). The switch computer component 132 may be owned and/or operated, for example, by a payment processing entity such as Mastercard International Incorporated. The switch computer component 136 also works together with the DES system computer 130 to allow for secure checkout for purchase transactions across multiple platforms, such as over the Internet (web interface), via an Android™ app and/or via an iOS™ app, on any type of mobile devices, including smartphones, digital wearable devices, and/or the like. In some embodiments, a Payment Services Provider (PSP) computer (not shown) may be used for conducting online transactions.

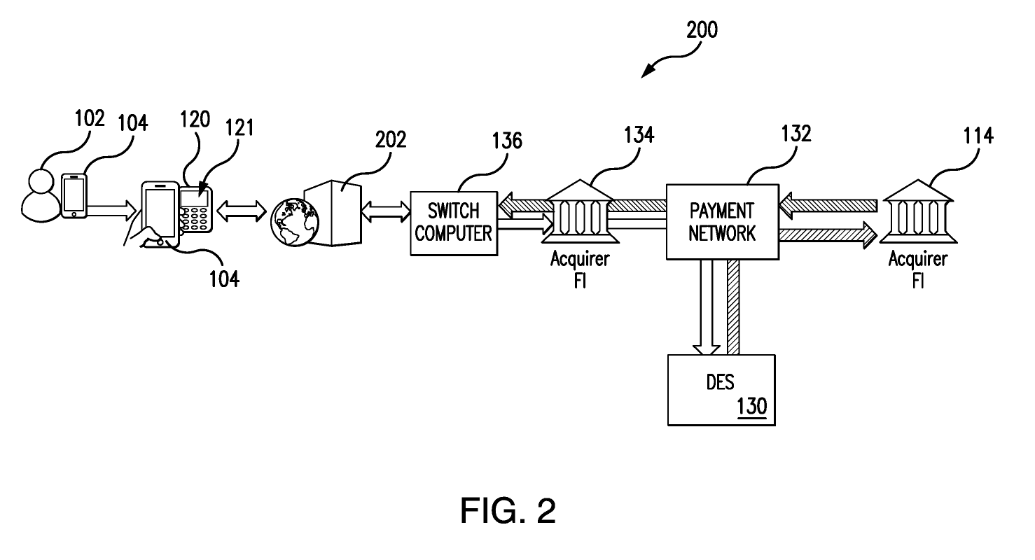

FIG. 2 is a block diagram of a barcode (1D barcode or QR code) transaction and purchase authorization system 200 to illustrate transaction processes in accordance with some embodiments. For a smart card (i.e., M/Chip) transaction, the user 102 uses his or her mobile device 104 to select a payment card account from a digital wallet, and chooses to “Pay by Barcode,” which may be selected from a menu or User Interface (UI) presented on a display screen of the mobile device 104. A mobile wallet application or web wallet application then generates a QR code, which then appears on the display screen. The merchant then uses a camera component or scanner (not shown) of a merchant device 120 to scan the consumer generated QR code. The merchant device 120 then sends the QR code, which contains consumer payment card account information, and the transaction amount to the merchant system and wallet server 202 for processing. The user next receives a prompt to confirm and/or consent to payment, and this prompt may include a requirement to provide authentication data via a consumer verification method (CVM; such as providing a mobile personal identification number (PIN), bank login, device level authentication (DLA) data or biometric data) for a “Card Present” transaction. When the consumer confirms or consents to providing payment for the transaction (and, in some cases, provides CVM data), tokenized smart card data or Magstripe data (which may be used as a fallback process) is generated by the consumer's mobile wallet application. In some embodiments, Mobile Device (MD) and User Mobile Device (UMD) cryptograms are generated by the mobile wallet application in accordance with Mastercard™ Cloud Based Payments (MCBP) specifications 1.0/2.0 or above, and thus such cryptograms may also be valid for future releases of the MCBP specification (or updated to comply with such future releases). Next, purchase transaction authorization occurs by using “business as usual” (BAU) transaction processing of data utilizing the switch computer 136, acquire FI computer 134, payment network 132, the DES computer system 130, and the issuer FI computer 114.

Referring again to FIG. 2, for a digital secure remote payment (DSRP) transaction, the user 102 utilizes a mobile wallet application or a web wallet application to generate a 1-D barcode or a 2-D barcode (a QR code). In some other embodiments, the merchant utilizes a merchant device 120 to generate a QR code on a display screen 121. Thus, either the merchant scans the consumer generated barcode or QR code, or the consumer uses his or her mobile device and mobile payment application to scan a merchant generated QR code. Next, the user receives a notification to complete the transaction and is prompted to enter a CVM (i.e., a mobile PIN, biometric data, and the like) to verify the purchase transaction. A Digital Secure Remote Payment (DSRP) device token is then generated by the mobile payment application, if supported by the device, or a DSRP cloud token is retrieved from a wallet server. Next, purchase transaction authorization occurs by using “business as usual” (BAU) processing of data utilizing the switch computer 136, acquirer FI computer 134, payment network 132, the DES computer system 130, and the issuer FI computer 114.

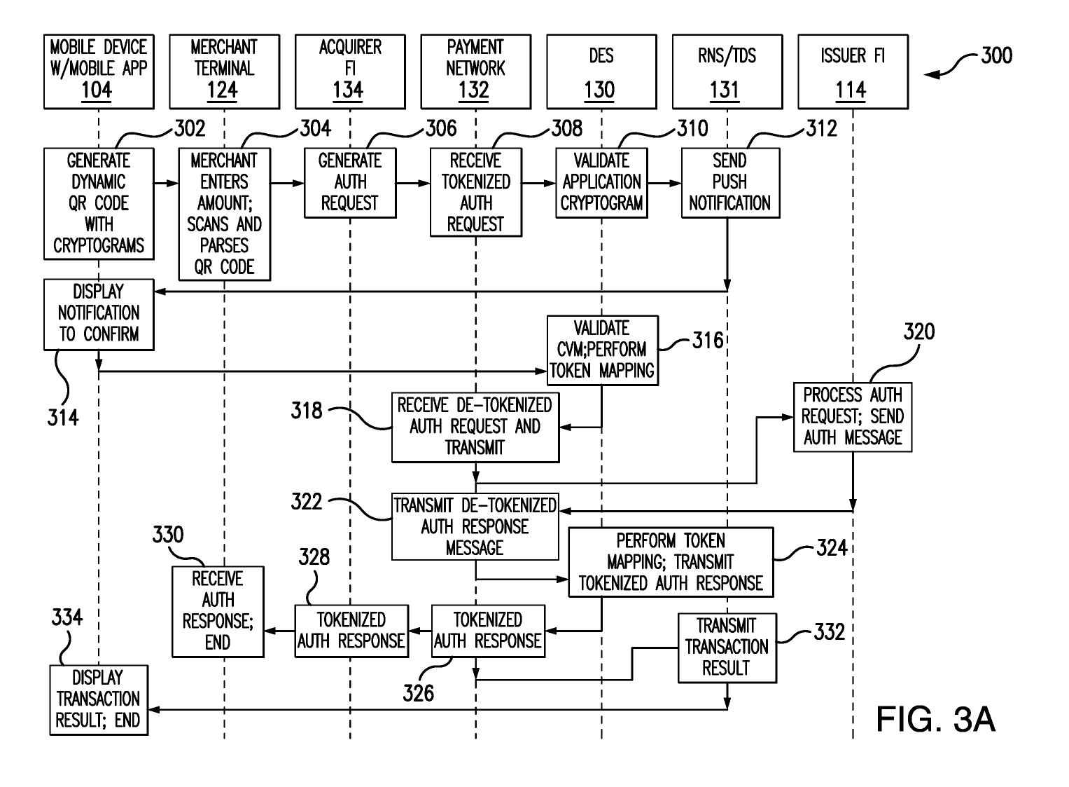

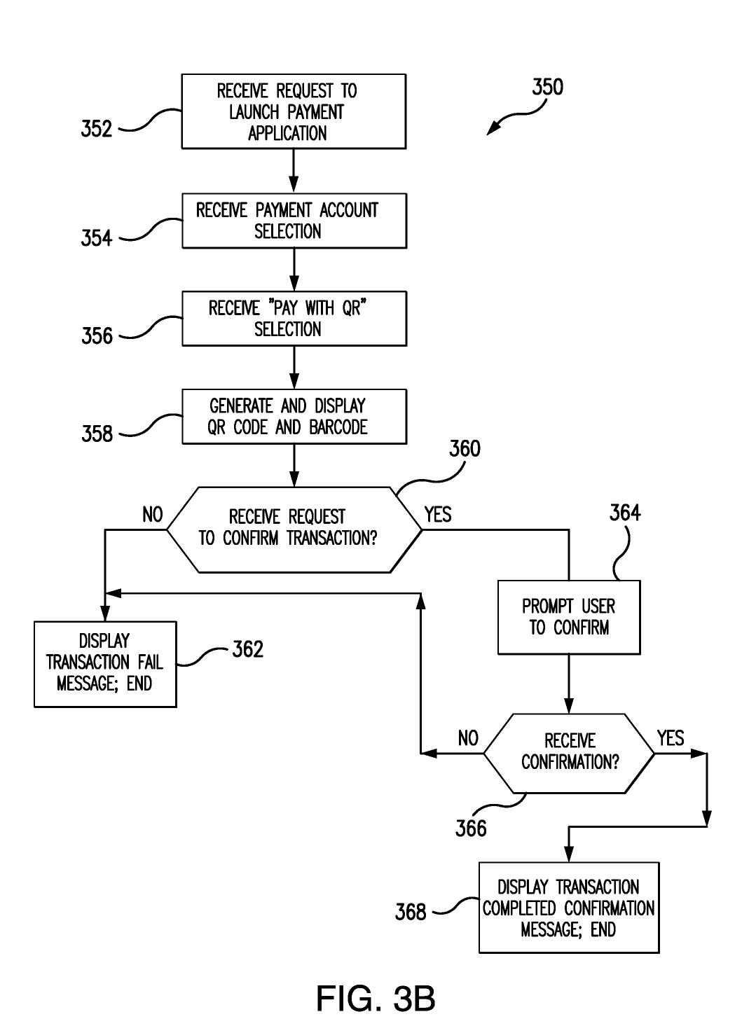

FIG. 3A is a flow diagram illustrating a consumer generated digital barcode (QR code) process 300 in accordance with some embodiments. In this example embodiment, the consumer or cardholder is in a merchant's retail store and wishes to utilize his or her mobile device 104 to pay for a purchase of item(s) and/or service(s). Thus, in an implementation the consumer launches a mobile payment application, selects a payment card account to use (from a menu of options), and then selects a “pay with QR code” process for use in the purchase transaction. In some embodiments, the consumer may then be prompted to enter cardholder identification data per a CVM by the mobile wallet application before the QR code is generated (and in some implementations the CVM methods used are as per Mastercard Cloud Based Payment (MCBP) 1.0/2.0 specifications, or above). For example, the cardholder may be prompted to provide biometric data (such as a fingerprint) by the mobile wallet application 108 running on the user's mobile device 104 (see FIG. 1) before generating 302 a dynamic QR code. In addition, in some implementations the CVM information entered by the user may be utilized to generate a cryptogram (which may be in accordance with the MCBP 1.0/2.0 specification). The dynamic QR code is then displayed on a display component (not shown) of the consumer's mobile device. Thus, the QR code contains the consumer's payment information (including token account information), an M/Chip application cryptogram, M/Chip data, a Mag stripe application cryptogram, and track 2 data.

Referring again to FIG. 3A, the merchant scans items to arrive at a total purchase transaction amount or otherwise enters 304 the transaction amount (a money value, for example, U.S. dollars and cents) into a point of sale (POS) terminal 124 or into the merchant device 122 (FIG. 1). Next, the merchant scans and parses 304 the user-generated QR code. The merchant POS then sends the QR code data (containing the application cryptogram) to an acquirer FI computer 134 which generates 306 a tokenized purchase transaction authentication request and transmits it to the payment network 132. Next the payment network transmits the tokenized purchase transaction authentication request to the DES (digital enablement system) computer 130, which validates 310 the application cryptogram for the purchase transaction. In some implementations, the DES computer 130 next transmits 310 a push notification directly to a Remote Notification Service (RNS)/Transaction Detail Service (TDS) 131 (wherein the TDS is an RNS managed by DES), or managed by the wallet service provider, or by a third party (e.g., Google™ or Firebase Cloud Messaging for Android™, ANS for iOS, etc.) or managed by the issuer. The RNS/TDS then transmits 312 the push notification to the consumer's mobile device 104 (which has an active mobile wallet application and has Internet and/or wireless connectivity), which includes a request for consent from the consumer to the purchase transaction. The confirmation message is received by the consumer's mobile device 104 and displayed 314 on a display component for the user to consider, which consent must be provided within a certain amount of time or else the transaction authorization process will terminate. It should be understood that, in embodiments where the Wallet Service Provider of, for example, an X-Pay wallet is transmitting the push notification, the consumer's mobile device would require wireless connectivity (for example, Internet and/or Bluetooth connectivity, or the like).

The transaction confirmation message may include details of the transaction, such as the time of purchase, the merchant's name, location data, name/display of item(s) being purchased, the transaction amount and currency, the payment method used, and a card image. At this point in the process, the consumer may also be prompted to also enter a CVM on the mobile device (DLA) or mobile wallet application (mobile/wallet PIN, biometrics, etc.), which may occur for example, when velocity checks were not passed, and/or when a CVM was not entered by the consumer via the mobile wallet application prior to generating the QR code, and/or when the transaction is a high value transaction, and/or the number of transactions without CVM entry exceeded a certain limit. In some implementations, the transaction confirmation message may also provide the consumer with the option to cancel the transaction (for example, a “Cancel” radio button may be provided which the consumer may select to end the process, or a “Back” button may be provided for the consumer to re-start or end the process). In some implementations, the push notification may be transmitted by the DES 130 via the payment network 132 to an RNS managed by the DES and/or the issuer/wallet service provider, or via the Masterpass™ switch 136, and then to the consumer's mobile device 104.

As shown in FIG. 3A, when the user confirms the transaction (for example, by pressing a “Confirm” radio button appearing on the display screen, and/or by entering CVM), then a confirmation message is transmitted to the DES 130 along with the CVM data, and the DES validates 316 the application cryptogram that may contain CVM data, and performs token mapping. Next the DES transmits the de-tokenized, verified purchase authentication request to the payment network 132, which then transmits the de-tokenized, verified purchase transaction authorization request to the issuer FI computer 114 for purchase transaction authorization processing (financial approval). Thus, the issuer FI 114 processes 320 the purchase transaction authorization request, and if all is in order (i.e., the consumer's payment account is in good standing and has an adequate credit line), transmits a de-tokenized authorization response message to the payment network 132. The payment network 132 receives it, and then transmits 322 the de-tokenized authorization response message to the DES computer 130, which performs 324 token mapping, and then transmits the tokenized authorization response to the payment network 132. The payment network then transmits 326 the tokenized authorization response to the to the acquirer FI computer 134, which in turn transmits 328 the tokenized authorization response to the merchant terminal 124. When the merchant terminal 124 receives the tokenized authorization response, in some embodiments an authorization message is displayed for the benefit of a store clerk or cashier (and the consumer) and the process ends.

Referring again to FIG. 3A, in step 326, in some embodiments the payment network 132 also transmits the transaction result to the RNS/TDS 131. The RNS/TDS 131 then generates and transmits 332 a transaction result message to the consumer's mobile device 104, where it is displayed 334 for the consumer. Thus, in some embodiments the consumer receives an acknowledgement/confirmation message via the mobile wallet application, which may be transmitted from an issuer RNS, wallet service provider RNS, third party RNS, or TDS (which is an RNS managed by the DES) after the transaction has been authorized (or declined), and assuming that internet and/or wireless connectivity exists. The process then ends.

FIG. 3B is a flowchart illustrating a consumer generated 1D digital barcode and QR code process 350 in accordance with some embodiments. The user mobile device receives 352 a request from the user or cardholder to launch a mobile payment application, receives 354 a payment card account selection, and then receives 356 a “Pay with QR code” selection. In some embodiments, a mobile wallet application 108 is running on the user's mobile device which then generates and displays 358 both a dynamic QR code and a 1D digital barcode on a display component (such as a touchscreen). Assuming the mobile device has internet connectivity, the mobile wallet application then waits to receive 360 a request to confirm the purchase transaction, and if the request to confirm the purchase transaction is not received within a predetermined amount of time, then the consumer mobile device displays 362 a transaction fail message on the display screen, and the process ends. However, if the request to confirm the purchase transaction is received in step 360, then the user is prompted 364 to confirm the transaction (for example, a confirmation message may be displayed that includes purchase transaction details, including the time of purchase, the merchant's name, location data, name/display of item(s) being purchased, the transaction amount and currency, the payment method used, and a card image, and that includes a “Confirm” button displayed on the touchscreen, and/or an option to enter CVM). In some embodiments, if CVM was not provided earlier (or if expired and/or velocity checks failed), the user may be requested to provide a CVM (for confirmation purposes). If the user does not provide a confirmation indication in step 366 within a predetermined amount of time (or selects a “Cancel” option that may be provided), then the consumer mobile device displays 362 a “transaction fail” message (or displays a “transaction canceled” message if the consumer selected same) on the display screen, and the process ends. However, if a confirmation is received from the consumer within a predetermined amount of time, then the transaction is completed and the cardholder's mobile device displays 368 a transaction completed confirmation message (assuming the mobile device has internet connectivity) and the process ends.

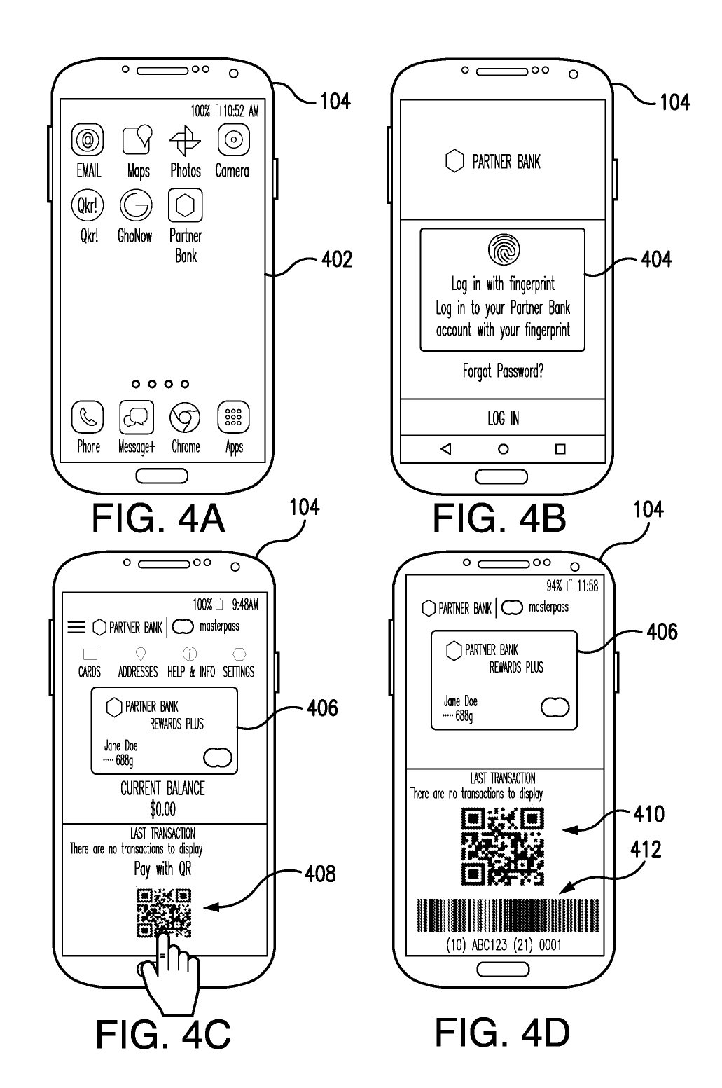

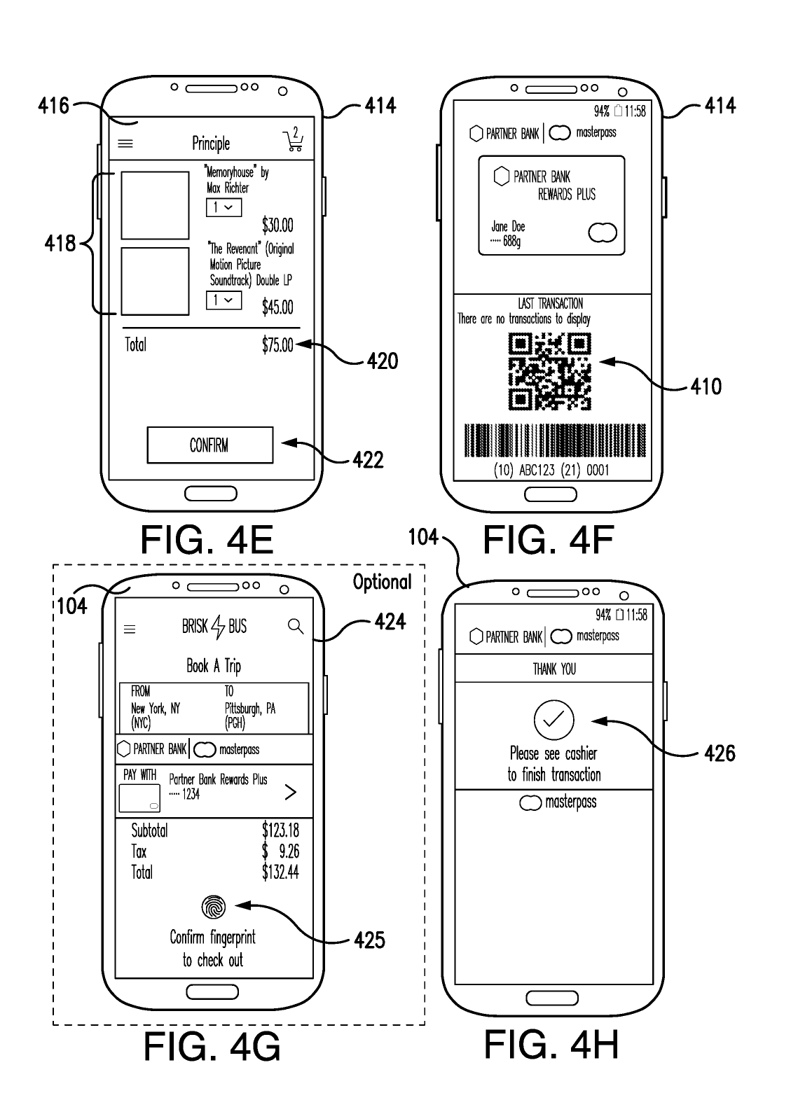

FIGS. 4A-4H illustrate examples of screen displays (or screen shots) of mobile device user interface screens associated with a smart card and/or magstripe purchase transaction featuring a consumer generated QR code process in accordance with some embodiments. FIG. 4A depicts a user mobile device 104 or smartphone that includes a display screen 402 with various icons which can be selected by the user to perform various functions. With regard to conducting a purchase transaction, the consumer or user launches a mobile application and is presented with the user login screen 404 shown in FIG. 4B, which in this example prompts the user to “Log in with fingerprint” to the selected issuer mobile wallet. (It should be noted that the processes disclosed herein are not limited to an issuer wallet, as other digital wallets, such as a Masterpass™ direct wallet or a DAC wallet may be utilized.) In some implementations, the user can login via other types of existing device or application credentials, such as by providing other DLA (device unlock pattern, passcode, and the like) types of biometric data (such as iris scan data or facial data), or by using a mobile/wallet PIN, as required by the mobile app. Depending on the wallet security preferences, and/or if velocity checks pass (which velocity checks may be performed by the mobile application), the user may not be requested to provide a CVM for login.

Next, as shown in FIG. 4C, the user selects a payment card account and a representation of the payment card 406 is displayed along with an option to “Pay with QR” 408, which is then selected by the user to initiate a QR code payment. (In some embodiments, the “Pay with QR” option may include an option to scan a merchant QR code as well.) The mobile application next generates and displays a QR code 410 and a barcode 412 on the display screen (along with the representation of the payment card 406). At least one of the QR code 410 and/or the barcode 412 can be read by the merchant's device.

As shown in FIG. 4E, a merchant device 414 (which in this example is another smartphone) includes a display screen 415 which depicts the merchants' name 416, a list of the items 418 selected by the user for purchase and their cost, a total amount due 420, and a “Confirm” button 422. In some implementations, a “Cancel” button (not shown) or “Back” button (not shown) may also be provided for selection by the merchant. In some embodiments, the merchant enters the amount data, and then presses the “Confirm” button 422 when satisfied. Next, the merchant uses the merchant device to scan or read the QR code 410 displayed on the user's mobile device 104 (shown in FIG. 4F) by using a camera component (not shown) of the merchant device 414. In some implementations, as shown in FIG. 4G, the user next receives a push notification 424 on the display screen of the user's mobile device 104 (assuming the user has an active mobile wallet application installed on the device and Internet connectivity) requesting confirmation of payment from the selected payment card account for the amount entered by the merchant, which may include a message to “Confirm fingerprint to check out” along with an icon 425 illustrating the position where the user should touch the display screen. If not provided earlier, or if expired/velocity checks fail, the user may be requested to provide a CVM for confirmation purposes. The user may also be asked to enter other CVM data (a mobile/wallet PIN, biometric data, device level authentication (DLA) or the like). Lastly, as shown in FIG. 4H, the user receives a confirmation message 426 on the display screen of the user mobile device 104 (when Internet connectivity is available on the consumer's device).

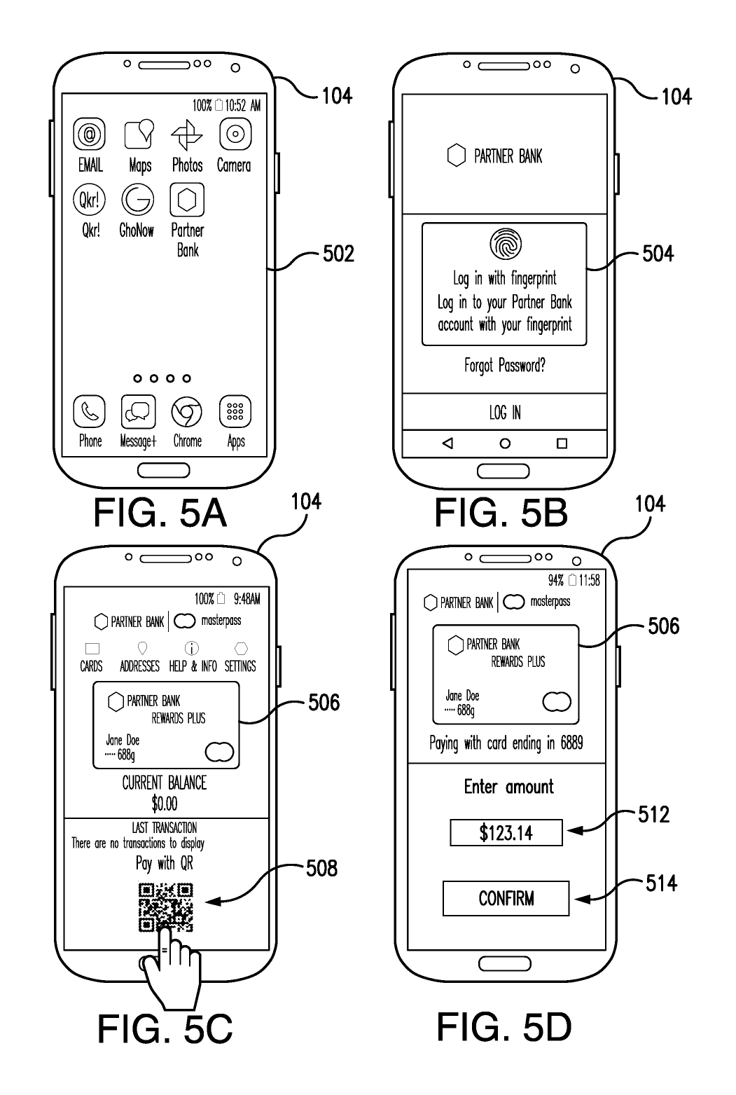

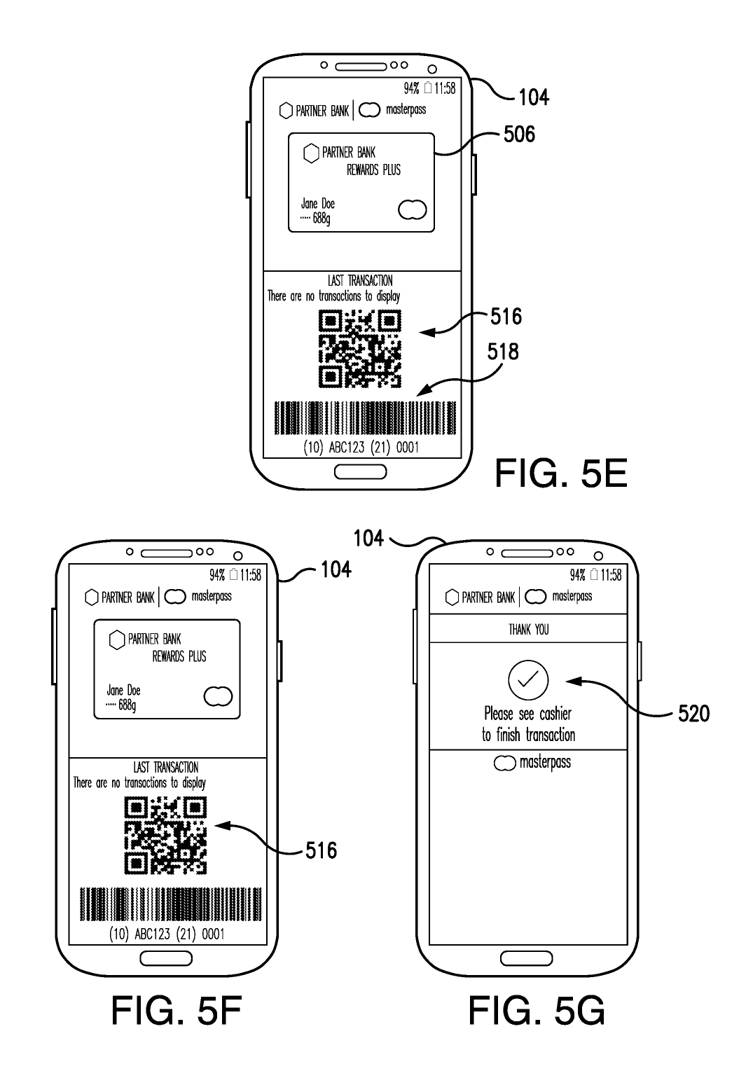

FIGS. 5A-5G illustrate examples of screen displays (or screen shots) of mobile device user interface screens associated with a smart card and/or magstripe purchase transaction featuring an alternate consumer generated QR code process in accordance with some embodiments. In FIG. 5A, the cardholder utilizes his or her mobile device 104, such as a smartphone that includes a display screen 502, to select and launch a mobile application. As shown in FIG. 5B, the cardholder utilizes a user login screen 504 which in this example prompts the user to “Log in with fingerprint” to the selected “issuer mobile wallet.” (It should be understood that the processes disclosed herein are not limited to an issuer wallet, as other digital wallets, such as a Masterpass™ direct wallet or a DAC wallet may be utilized.) In some implementations, the user can login via other types of existing application credentials, such as by providing biometric data (such as iris scan data or facial data), DLA, or by using a mobile/wallet PIN, as may be required by the mobile app. Depending on the wallet security preferences, or if velocity checks pass, the user may not be requested to provide a CVM to login. Next, as shown in FIG. 5C, the user selects a payment card account and a digital representation of the payment card 506 is displayed along with an option to “Pay with QR” 508, which the user selects to initiate a QR code payment.

As shown in FIG. 5D, the user is then presented with a screen that shows the payment card representation 506 and includes an entry box 512 to enter a total amount of the purchase transaction. The consumer then enters the transaction amount in the entry box 512 and selects the “Confirm” button 514. If not provided earlier, or if expired/velocity checks fail, the user may be requested to provide a CVM. Next, as shown in FIG. 5E, the mobile application displays the payment card representation 506 and generates and displays a QR code 516 and a barcode 518 on the display screen. At least one of the QR code 516 and/or the barcode 518 can be read by the merchant's device, and in this example, as shown in FIG. 5F, the merchant utilizes a scanner or a camera component (not shown) associated with a merchant device to scan the QR code 516. When the scan is successful, as shown in FIG. 5G, the user receives a confirmation message 520 on the display screen of the user mobile device 104. The confirmation message 520 may include an instruction to see the merchant's cashier to finish the transaction.

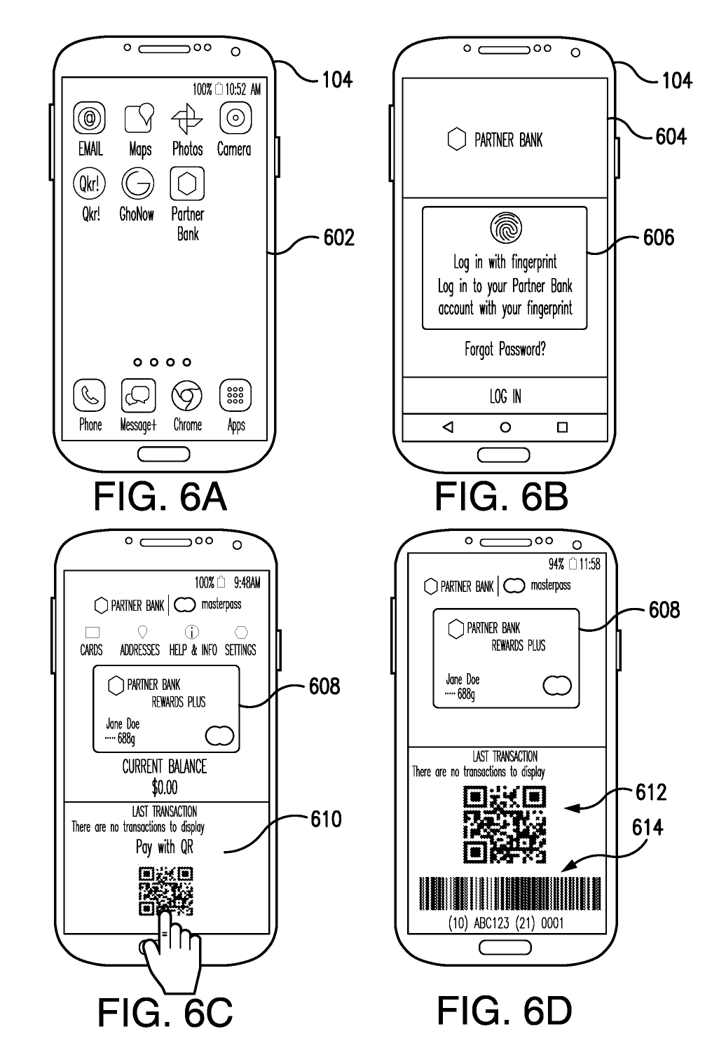

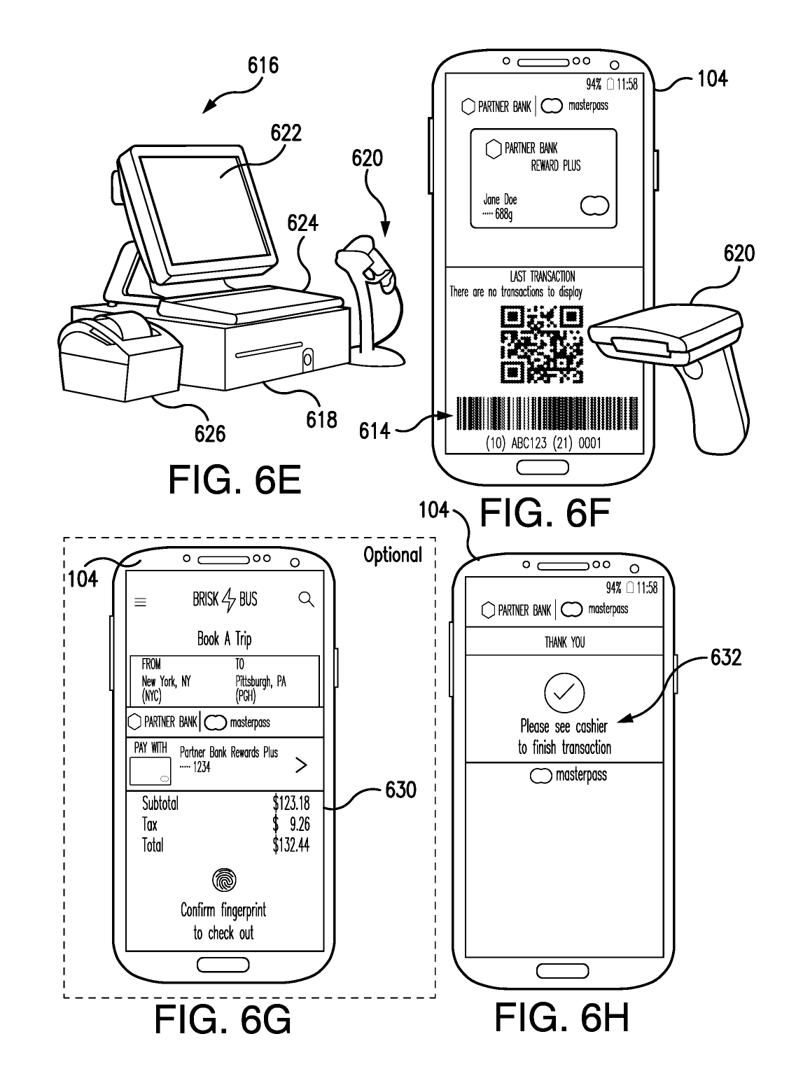

FIGS. 6A-6H illustrate examples of screen displays (or screen shots) of mobile device user interface screens associated with a digital secure remote payment (DSRP) transaction featuring a consumer generated QR code process in accordance with some embodiments. FIG. 6A depicts a user mobile device 104 or smartphone that includes a display screen 602 with various icons which can be selected by the user to perform various functions. When conducting a purchase transaction, the consumer or user launches a mobile payment application and is presented with the user login screen 604 shown in FIG. 6B, which in this example prompts the user to “Log in with fingerprint” 606 to the selected “issuer mobile wallet” (as noted above, the processes disclosed herein are not limited to an issuer wallet, as other digital wallets, such as a Masterpass™ direct wallet or a DAC wallet may be utilized). In some implementations, the user may be prompted to login by using other types of existing application credentials, such as wallet application credentials (e.g. username, password), issuer online/mobile banking credentials, other biometric data (such as iris scan data or facial data), DLA, or by using a mobile/wallet PIN, as required by the mobile app. Depending on the wallet security preferences, or if velocity checks pass, the user may not be requested to provide a CVM for login.

Next, as shown in FIG. 6C, the user selects a payment card account and a representation of the payment card 608 is displayed along with an option to “Pay with QR” 610, which is then selected by the user to initiate a QR code payment. Then, as shown in FIG. 6D, the mobile application generates and displays a QR code 612 and a barcode 614 on the display screen (along with the representation of the payment card 608). At least one of the QR code 612 and/or the 1D barcode 614 can be read by the merchant's device.

FIG. 6E illustrates an example of a merchant device 616, which in this embodiment is a POS terminal 618 having an associated barcode scanner 620, display screen 622, keyboard 624, and receipt printer 626. At this point in the process, the merchant enters the amount of the transaction, for example, by using the keyboard 624 (and/or by using the scanner 620 to scan item barcodes in order to automatically generate a list of items and their associated costs). Next, as depicted in FIG. 6F, the merchant utilizes the barcode scanner 620 to scan the user-generated barcode 614 appearing on the display screen of the consumer's mobile device 104. In some implementations, as shown in FIG. 6G, assuming the user's device has Internet connectivity, the user next receives a push notification 424 on the display screen of the user's mobile device 104 to complete the transaction by entering consumer verification method (CVM) data (a mobile/wallet PIN, DLA, biometric data, or the like). Lastly, as shown in FIG. 6H, the user receives a confirmation message 632 on the display screen of the consumer mobile device 104, assuming the user's device has internet connectivity.

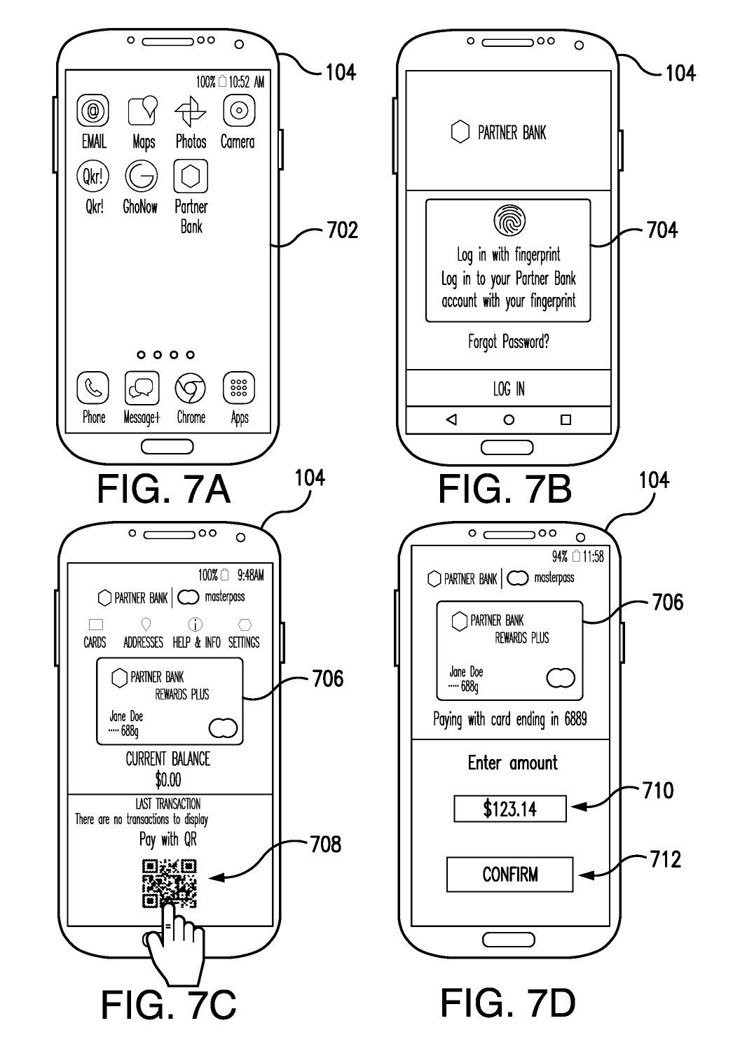

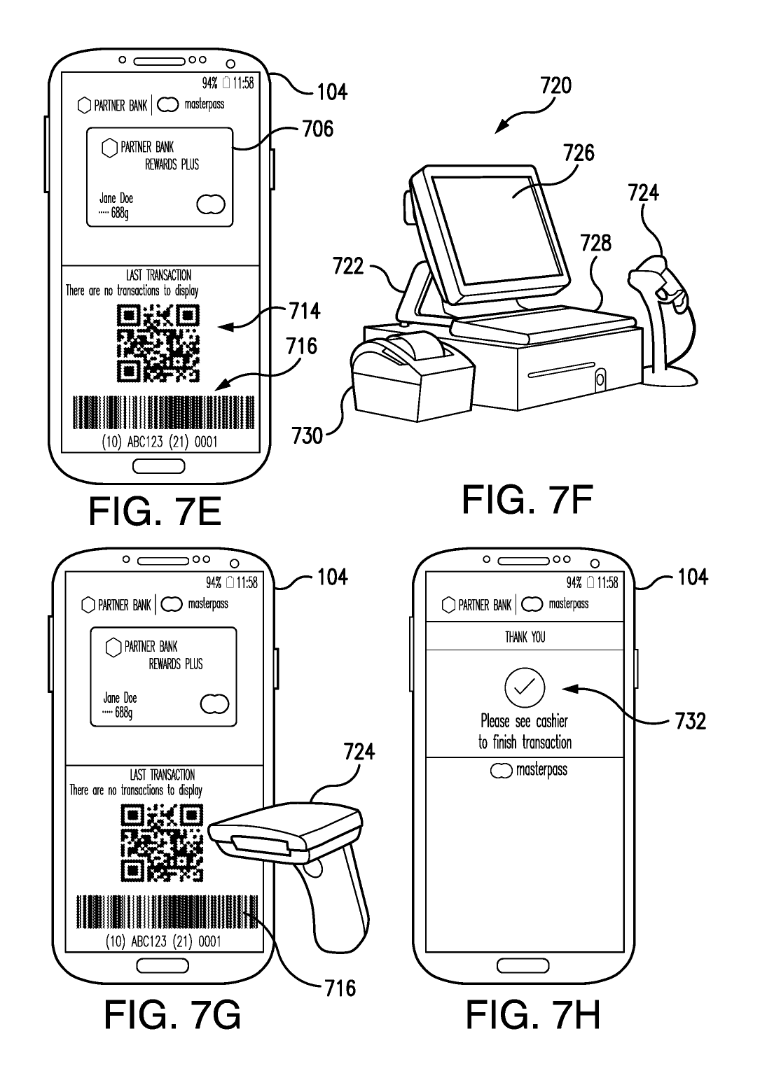

FIGS. 7A-7H illustrate examples of screen displays (or screen shots) of mobile device user interface screens associated with a digital secure remote payment (DSRP) transaction featuring a consumer generated QR code process in accordance with some embodiments. In FIG. 7A, the cardholder utilizes his or her mobile device 104, such as a smartphone that includes a display screen 702, to select and launch a mobile wallet application. If not provided earlier, or if expired/velocity checks fail, the user may be requested to provide a CVM to generate a 1D and a 2D barcode. As shown in FIG. 7B, the cardholder utilizes a user login screen 704 which in this example prompts the user to “Log in with fingerprint” to the selected “issuer mobile wallet.” (As noted above, the processes disclosed herein are not limited to an issuer wallet, as other digital wallets, such as a Masterpass™ direct wallet or a DAC wallet may be utilized.) In some implementations, the user can login via other types of existing application credentials, such as by providing biometric data (such as iris scan data or facial data), or by using a mobile/wallet PIN, issuer online/mobile banking credentials, mobile app credentials (e.g. username and password), as may be required by the mobile app. Depending on the wallet security preferences, or if velocity checks pass, the user may not be requested to provide a CVM for login. Next, as shown in FIG. 7C, after the user selects a payment card account a digital representation of the payment card 706 is displayed along with an option to “Pay with QR” 708, which the user selects to initiate a QR code payment.

As shown in FIG. 7D, the user is then presented with a screen that shows the payment card representation 706 and includes a manual entry option 710 for entering a total amount of the purchase transaction (in which the user entered $123.14). In some implementations, the mobile app automatically may calculate the total taxes included using location information obtained from the device, or an option may be provided to enter a state and/or merchant location, or the taxes could be added by the merchant POS after the barcode is scanned. Referring again to FIG. 7D, after the consumer enters the transaction amount in the entry box 710 and selects the “Confirm” button 712, the mobile application then generates and displays, as shown in FIG. 7E, a QR code 714 and a barcode 716 along with the payment card representation 706 on the display screen. (In some implementations, the consumer may also be provided with a “Cancel” button (not shown) option, which if selected ends the process.) At least one of the QR code 714 and/or the 1D barcode 716 can be read by the merchant's device.

FIG. 7F illustrates an example of a merchant device 720, which in this embodiment is a POS terminal 722 having an associated barcode scanner 724, display screen 726, keyboard 728, and receipt printer 730. At this point in the process, the merchant enters an amount of the transaction, for example, by using the keyboard 728 (and/or by using the scanner 724 to scan item barcodes in order to automatically generate a list of items and their associated costs). Next, as depicted in FIG. 7G, the merchant utilizes the barcode scanner 724 to scan the user-generated barcode 716 appearing on the display screen of the consumer's mobile device 104. When the barcode scan is successful, as shown in FIG. 7H, the user receives a confirmation message 732 on the display screen of the user mobile device 104, assuming internet connectivity exists, which may include an instruction to see the merchant's cashier to finish the transaction.

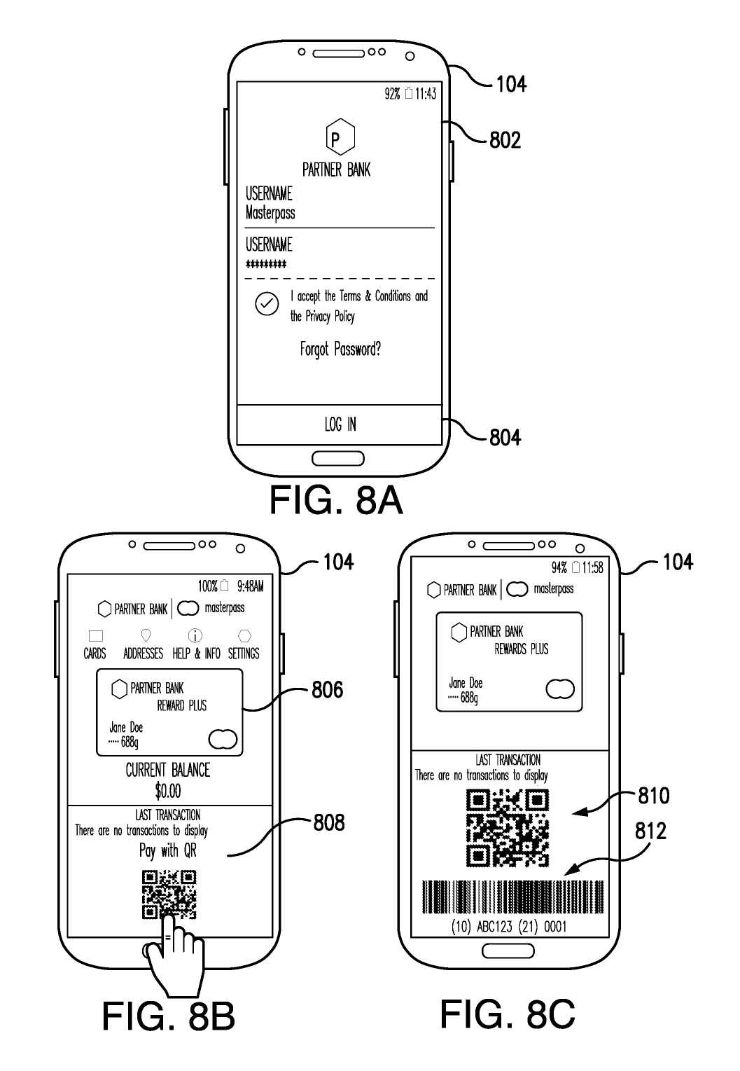

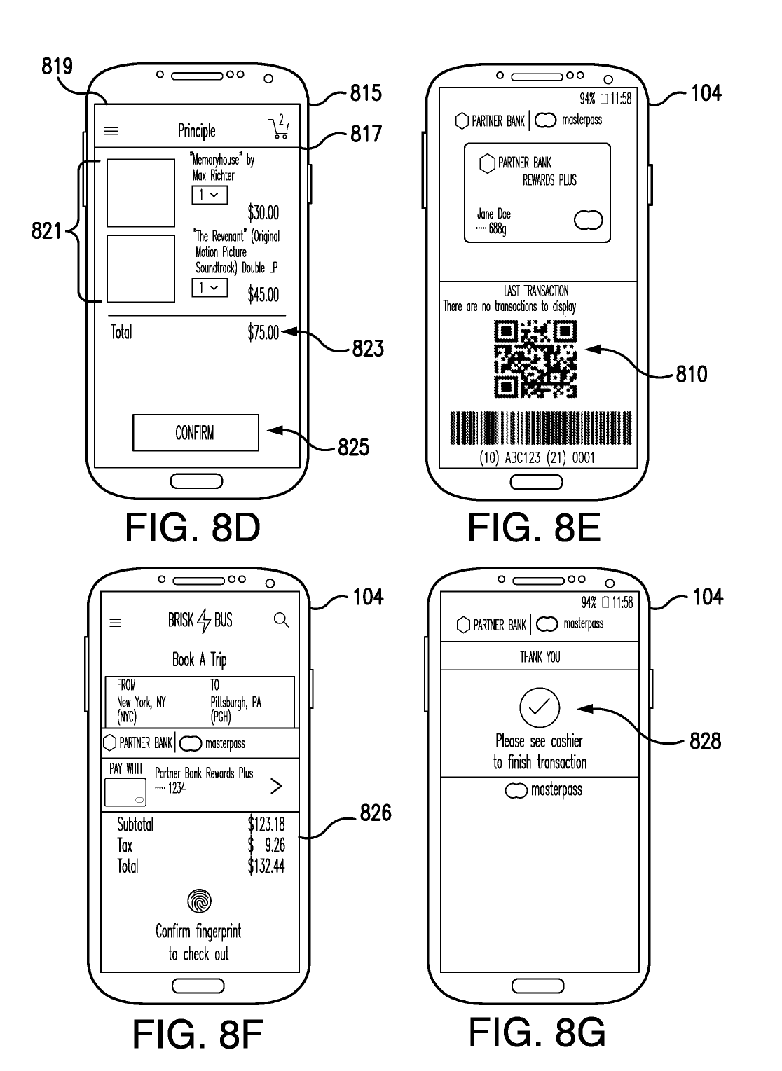

FIGS. 8A-8G illustrate examples of screen displays (or screen shots) of mobile device user interface screens associated with a purchase transaction featuring another consumer generated QR code process utilizing a web wallet in accordance with some embodiments. FIG. 8A depicts a user mobile device 104 or smartphone that includes a display component 802 which is displaying a web wallet login screen 804 for use by the consumer or user to launch a web wallet by entering, for example, a username and password or PIN, or if an issuer wallet, the issuer's online/mobile banking credentials. After launching the web wallet (on a mobile/web browser on the consumer's mobile device), the consumer selects a payment card and, as shown in FIG. 8B, is presented with a screen that includes a digital representation of the selected payment card 806 and an option to “Pay with QR” 808, which the user selects to initiate a QR code payment transaction. The web wallet then generates and displays a QR code 810 and a 1D barcode 812 on the display screen (along with the representation of the payment card 806). At least one of the QR code 810 and/or the barcode 812 can be read by the merchant's device.

As shown in FIG. 8D, a merchant device 815 (which in this example is another smartphone) includes a display screen 817 which depicts the merchants' name 819, a list of the items 821 selected by the user for purchase and their cost, a total amount due 823, and a “Confirm” button 825. (In some implementations, a “Cancel” button (not shown) or “Back” button (not shown) may also be provided for selection by the merchant, which if selected may end the process.) In some embodiments, the merchant manually enters the amount data on the merchant app or scans products to be purchased using the merchant app and the total amount (including any tax) is calculated by the merchant application automatically. Once the total amount and currency information is displayed correctly, the merchant then presses the “Confirm” button 825. Next, the merchant utilizes his or her merchant device 815 to scan or read the consumer generated QR code 810, as shown in FIG. 8E, which is displayed on the user's mobile device 104 by using a camera component (not shown). In some implementations, as shown in FIG. 8F, if a mobile wallet application is also present in the user's mobile device, the user may receive a push notification 826 (assuming the user has an active mobile wallet application on the device and Internet connectivity) on the display screen of the user's mobile device 104 requesting confirmation of payment from the selected payment card account for the amount entered by the merchant. In this case, the user may also be asked to enter CVM data (a mobile PIN, DLA, biometric data, or the like) on the mobile device or on the mobile wallet application. Lastly, as shown in FIG. 8G, the user receives a confirmation message 828 on the display screen of the user mobile device 104.

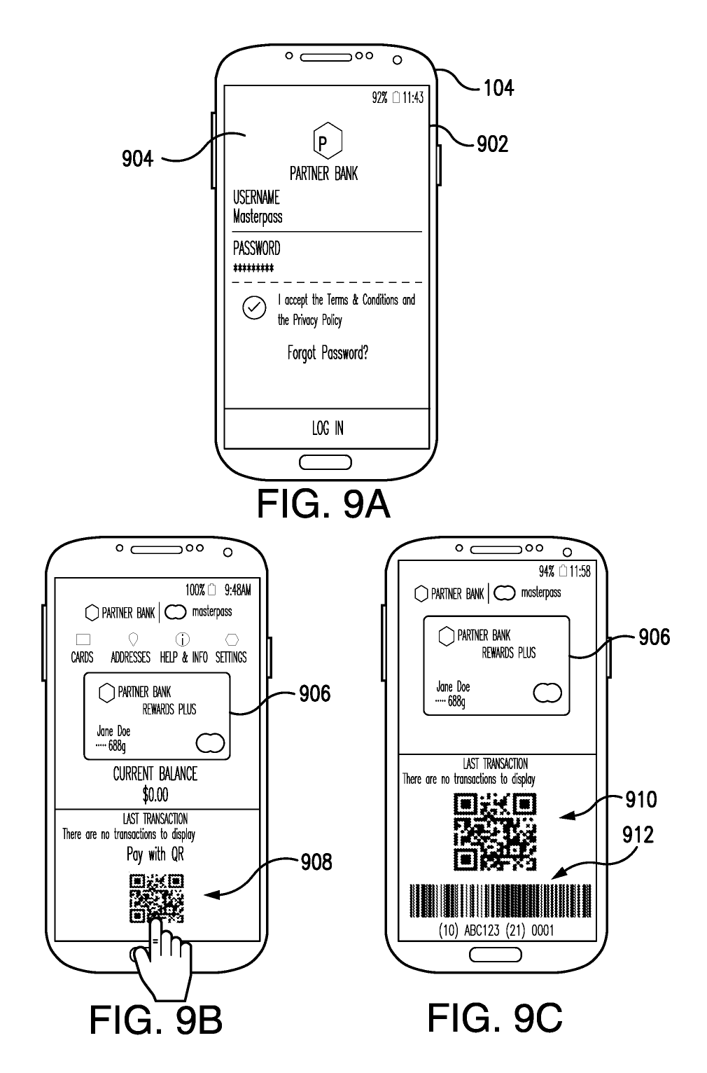

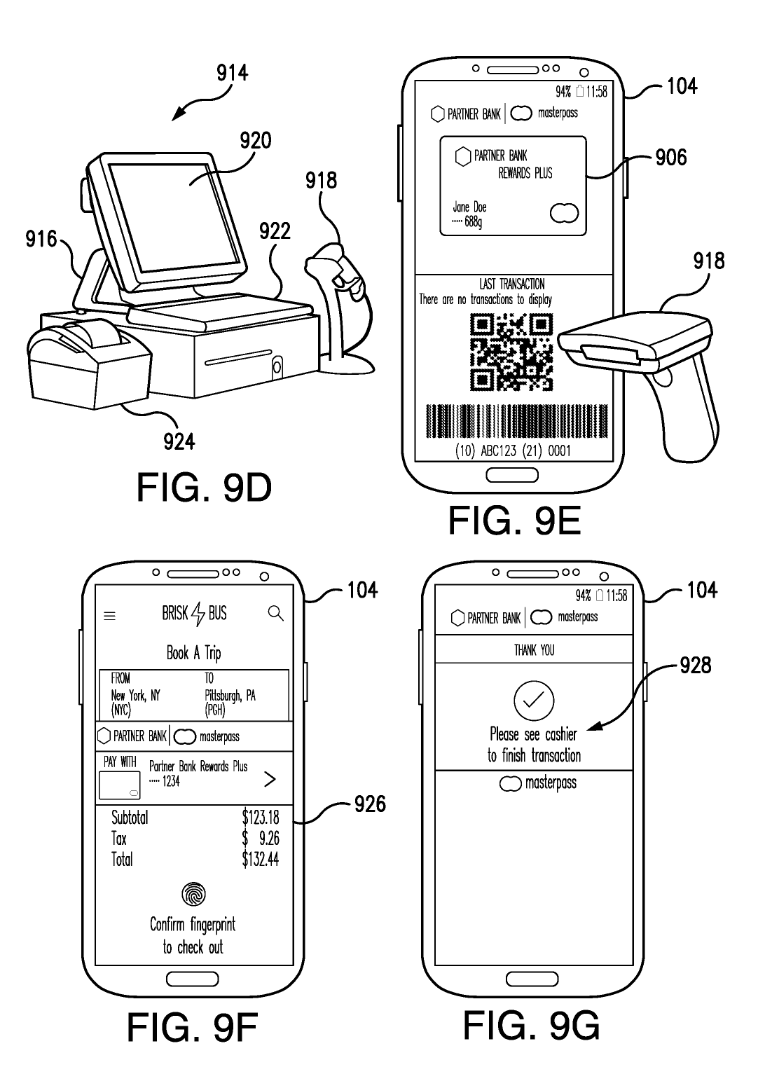

FIGS. 9A-9G illustrate examples of screen displays (or screen shots) of mobile device user interface screens associated with another DSRP transaction featuring a consumer generated QR code process utilizing a web wallet in accordance with some embodiments. FIG. 9A depicts a user mobile device 104 or smartphone that includes a display component 902 which is displaying a web wallet login screen 904 for use by the consumer or user to launch a web wallet by entering, for example, a username and password/PIN, or e.g. if an issuer wallet, issuer online/mobile banking credentials. After launching the web wallet, the consumer selects a payment card and, as shown in FIG. 9B, is presented with a screen that includes a digital representation of the selected payment card 906 and an option to “Pay with QR” 908, which the user selects to initiate a QR code payment transaction. As shown in FIG. 9C, the web wallet then generates and displays a QR code 910 and a barcode 912 on the display screen (along with the representation of the payment card 906). At least one of the QR code 910 and/or the barcode 912 can be read by the merchant's device.

FIG. 9D illustrates an example of a merchant device 914, which in this embodiment is a POS terminal 916 having an associated barcode scanner 918, display screen 920, keyboard 922, and receipt printer 924. At this point in the process, the merchant enters an amount of the transaction, for example, by using the keyboard 922 (and/or by using the scanner 918 to scan item barcodes in order to automatically generate a list of items and their associated costs). Next, as depicted in FIG. 9E, the merchant utilizes the barcode scanner 918 to scan the user-generated barcode 912 appearing on the display screen of the consumer's mobile device 104. As shown in FIG. 9F, the user next receives a push notification on the display screen of the user's mobile device 104 (assuming the user has an active mobile wallet application on the device and Internet connectivity), which may list details of the transaction, including the time of purchase, the merchant's name, location data, name/display of item(s) being purchased, the transaction amount and currency, the payment method used, and a card image. In order to complete the transaction, the user provides CVM data (which may be a mobile/wallet PIN, issuer online/mobile banking credentials, DLA, biometric data such as fingerprint data, or the like). As shown in FIG. 9F, a message on the display screen instructs the user to “Confirm fingerprint to check out,” and provides a fingerprint icon in the position where the consumer should touch the screen with a finger to confirm. Lastly, as shown in FIG. 9G, assuming the device has Internet connectivity, the user receives a confirmation message 928 on the display screen of the consumer mobile device 104 which may include instructions to “Please see cashier to finish transaction.”

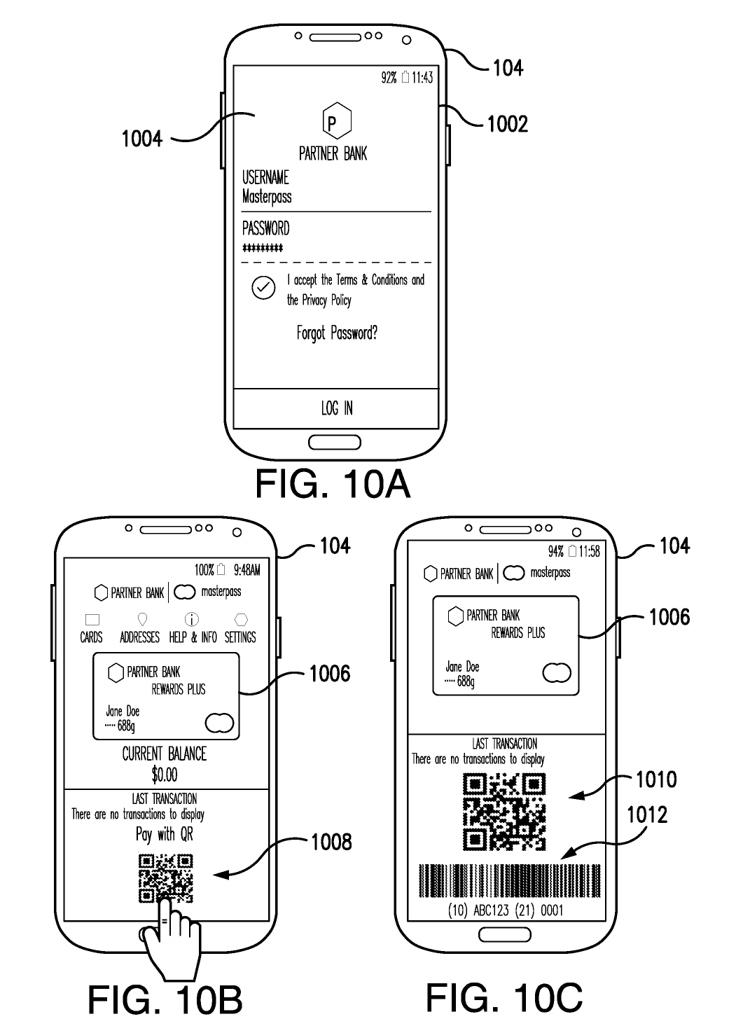

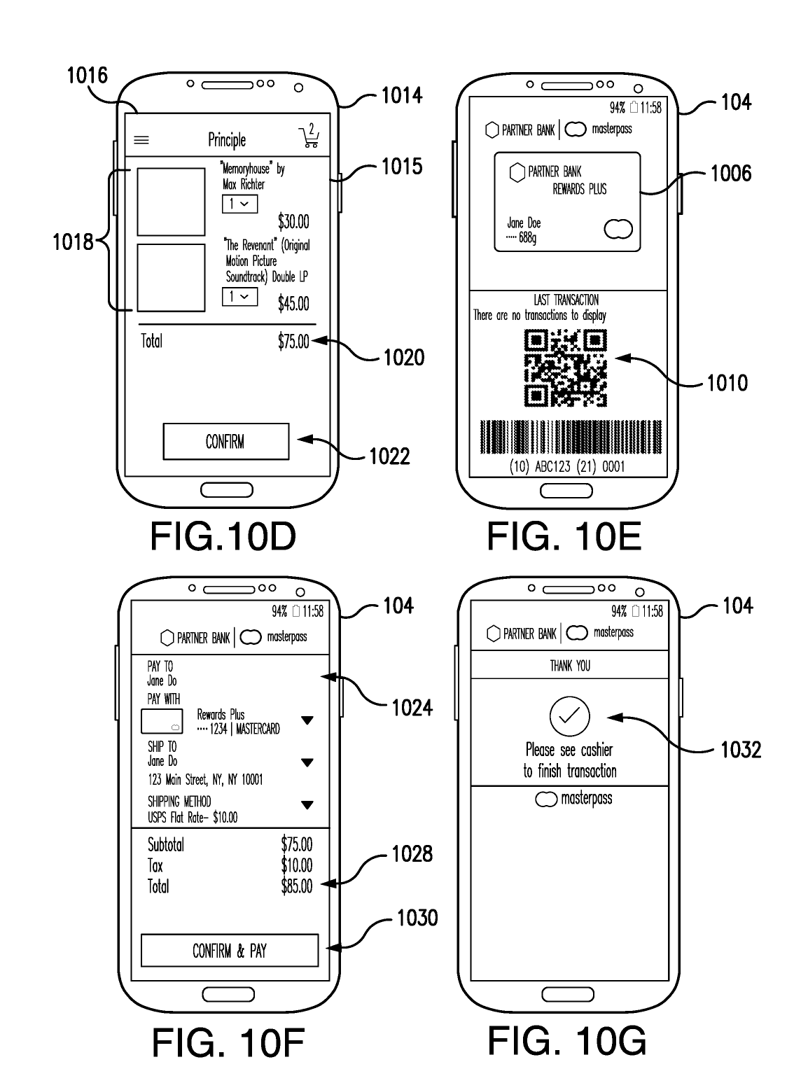

FIGS. 10A-10G illustrate examples of screen displays (or screen shots) of mobile device user interface screens associated with a DSRP transaction featuring an alternate consumer generated QR code process in accordance with some embodiments. FIG. 10A depicts a user mobile device 104 or smartphone that includes a display screen 1002 which is displaying a web wallet login screen 1004 for use by the consumer or user to launch a web wallet by entering, for example, a password. After launching the web wallet, the consumer selects a payment card and, as shown in FIG. 10B, is presented with a screen that includes a digital representation of the selected payment card 1006 and an option to “Pay with QR” 1008, which the user selects to initiate a QR code payment transaction. As shown in FIG. 10C, the web wallet then generates and displays a QR code 1010 and a barcode 1012 on the display screen (along with the representation of the payment card 1006), at least one of which codes can be read by the merchant's device.

FIG. 10D depicts a merchant device 1014 (which in this example is another smartphone) includes a display screen 1015 which depicts the merchants' name 1016, a list of the items 1018 selected by the user for purchase and their cost, a total amount due 1020, and a “Confirm” button 1022. In some implementations, a “Cancel” button (not shown) or “Back” button (not shown) may also be provided for selection. In some embodiments, the merchant entered the amount data, and then presses the “Confirm” button 1022 when satisfied, and next scans or reads the QR code 1010 displayed on the user's mobile device 104 (shown in FIG. 10E) by using the camera component (not shown) of his or her mobile device 1014. Next, as shown in FIG. 10F, the user receives a push notification 1024 (assuming the user has an active mobile wallet application on the device and Internet connectivity) on the display screen of the user's mobile device 104 requesting confirmation of payment from the selected payment card account 1026 for the amount listed 1028. If all appears in order, then the user touches the “Confirm & Pay” button 1030 to complete the transaction. In some implementations, however, the user may be asked to enter consumer verification method (CVM) data (such as a mobile PIN, biometric data, or the like), before pressing the “Confirm & Pay” button 1030. In either case, after the user presses the “Confirm & Pay” button, a confirmation message 1032 as shown in FIG. 10G is received and displayed on the display screen of the user mobile device 104.

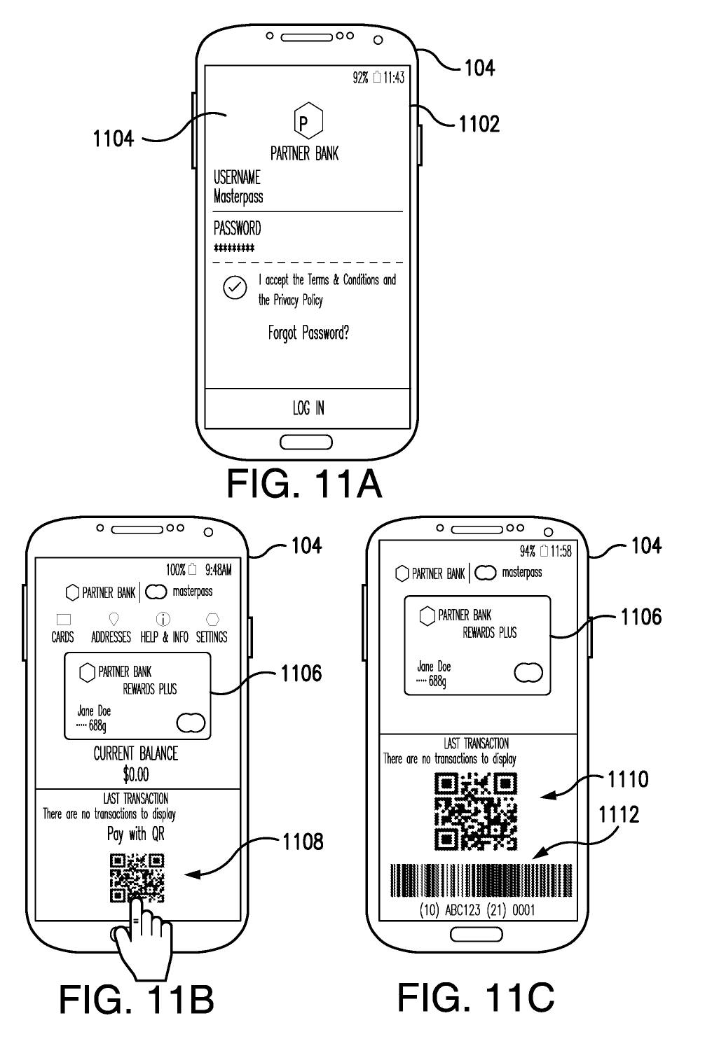

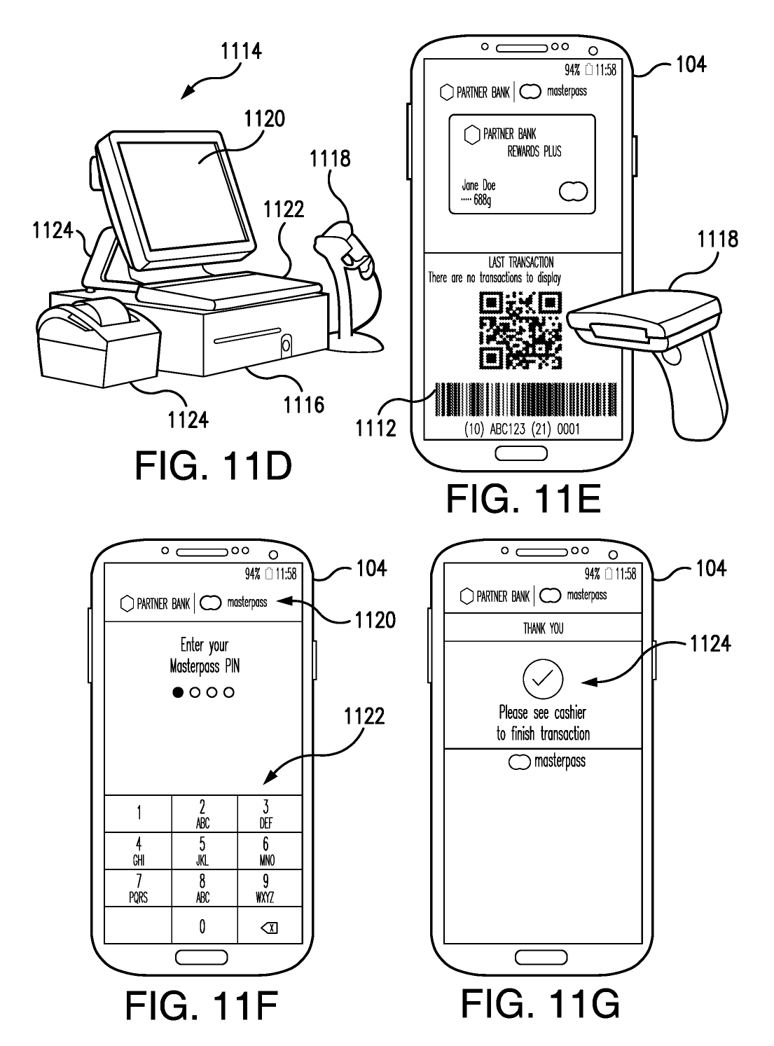

FIGS. 11A-11G illustrate examples of screen displays (or screen shots) of mobile device user interface screens associated with another digital secure remote payment (DSRP) transaction featuring a consumer generated one-dimensional barcode process utilizing a web wallet in accordance with some embodiments. FIG. 11A depicts a user mobile device 104 or smartphone that includes a display component 1102 which is displaying a web wallet login screen 1104 for use by the consumer or user to launch a web wallet and may require the entering of, for example, a password. After launching the web wallet, the consumer selects a payment card and, as shown in FIG. 11B, is presented with a screen that includes a digital representation of the selected payment card 1106 and an option to “Pay with QR” 1108, which the user selects to initiate a QR code payment transaction. If not provided earlier, the user may be requested to provide a CVM. As shown in FIG. 11C, the web wallet then generates and displays a QR code 1110 and a barcode 1112 on the display screen (along with the representation of the payment card 1106). At least one of the QR code 1110 and/or the barcode 1112 can be read by the merchant's device.

FIG. 11D illustrates an example of a merchant device 1114, which in this embodiment is a POS terminal 1116 having an associated barcode scanner 1118, display screen 1120, keyboard 1122, and receipt printer 1124. At this point in the process, the merchant enters an amount of the transaction, for example, by using the keyboard 1122 (and/or by using the scanner 1118 to scan item barcodes in order to automatically generate a list of items and their associated costs). Next, as depicted in FIG. 11E, the merchant utilizes the barcode scanner 1118 to scan the user-generated barcode 1112 appearing on the display screen of the consumer's mobile device 104. Next, as shown in FIG. 11F, the user is requested or prompted to confirm the transaction by selecting the “Confirm” button (or to cancel the transaction by selecting a “Cancel” button (not shown) on web wallet 1120 on the display screen of the user's mobile device 104, wherein transaction information is displayed. The transaction information includes the transaction amount (including taxes) and currency type, and other information, such as the payment method, billing address, location and merchant information, which may also be displayed. The user may also be requested to enter a mobile/wallet PIN or issuer bank login (or the like) using a touch screen keyboard 1122 for a Card Present transaction prior to or after selecting the “Confirm” button. After entering the requested mobile/wallet PIN or bank login, a confirmation message 1124 appears on the display screen as shown in FIG. 11G, which may include the details of the transaction, including the payment method, billing address, merchant information, and the like. In some implementations, a message such as “Please see cashier to finish transaction” may also be provided to the user.

As illustrated by FIGS. 4A to 11D, the consumer's mobile device is capable of quickly and easily generating barcodes (both a 1D and a 2D code) and displaying it on a display screen component to securely conduct purchase transactions, which can be any of a smart card (M/chip) transaction, mag stripe transaction or an in app (device) or web wallet (cloud) DSRP transaction. The generated QR code and/or 1D barcode can be read by different types of merchant devices, to thus ensure that a secure digital barcode transaction occurs. Such processing is advantageous because it is independent of merchant device and/or component configuration. For example, the QR code process can be utilized when the merchant device is a POS terminal with a barcode reader, or a POS device with a QR code scanner, or a smartphone that includes an integrated digital camera, to ensure that a secure purchase transaction occurs. In some embodiments, the merchant device using a mobile app would incorporate a merchant SDK (for example, provided by Mastercard) that would support the digital barcode transactions. In such a case, the merchant server would also be integrated with the (Masterpass™) switch for processing of the payment during the checkout process.

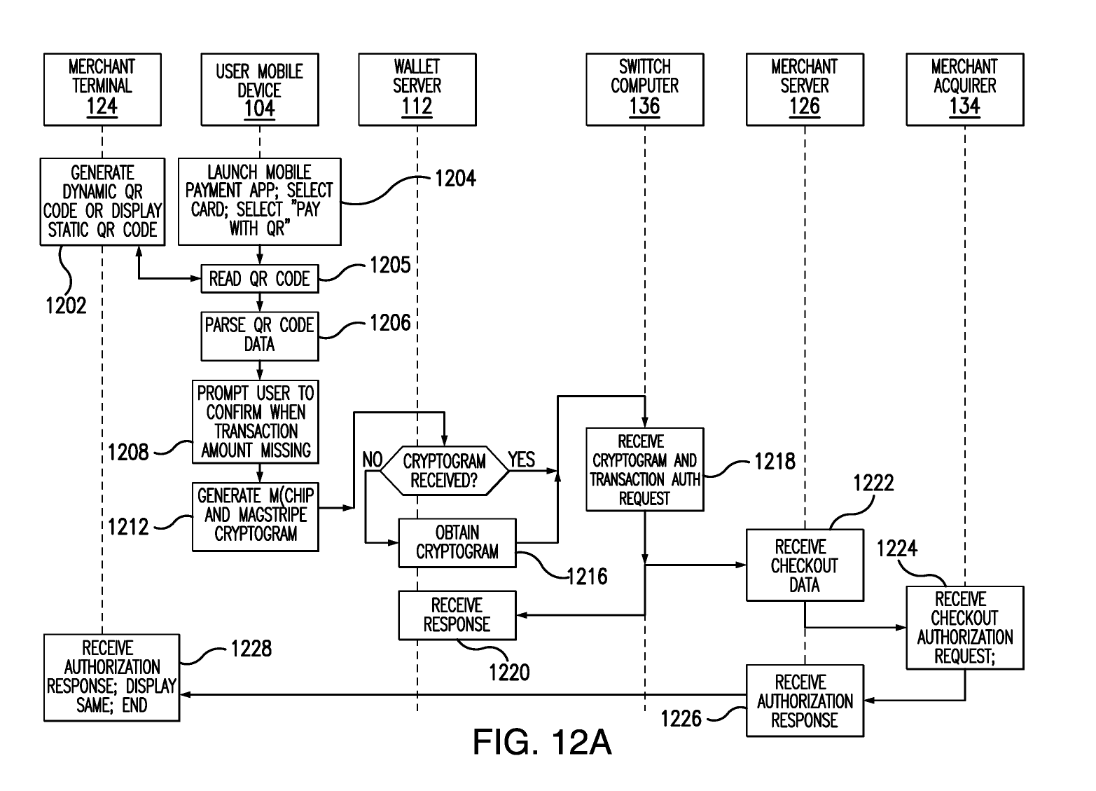

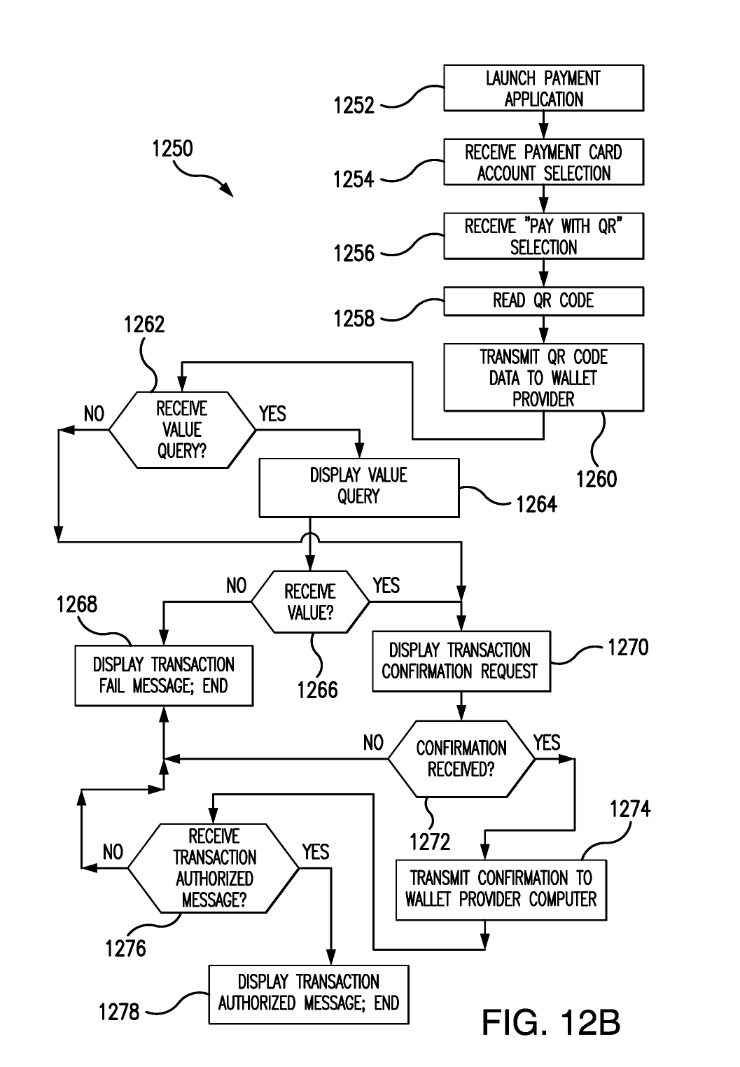

In some embodiments, instead of the consumer generating a 1D barcode and/or QR code with his/her mobile device for use in a secure purchase transaction process, the merchant utilizes a merchant device (for example, a point of sale (POS) terminal and/or a merchant smartphone) to generate a QR code and/or a 1D barcode. Thus, FIG. 12A is a flow diagram illustrating a merchant generated QR code process 1200 in accordance with some embodiments. In this example, the merchant terminal 124 (which may be a POS terminal) generates 1202 a dynamic QR code (which may include data such as a total amount of the purchase transaction (including any tax), currency, the time and date of the transaction, a merchant identifier, transaction identifier, a nonce and/or other data), or displays a static QR code (which may include merchant identification data). The cardholder then utilizes his or her mobile device 104 to launch 1204 a mobile payment application, selects a payment card account to use for the transaction, and selects a “Pay with QR code” option. Next, the cardholder's mobile device reads 1205 the merchant QR Code and parses 1206 the QR code data. When the transaction amount is not included in the QR code data (which is an indication that it is a static QR code), then the mobile payment application on the cardholder's mobile device 104 prompts 1208 the cardholder to confirm the transaction by providing the transaction amount, and in some cases also providing a CVM. In some implementations, after the cardholder either enters the purchase transaction amount in step 1208 (and the CVM, if required), or after the cardholder's mobile wallet application receives the transaction amount within the QR code data (e.g., in step 1206 it is determined that the QR code data does include the transaction amount), then mobile wallet application generates 1212 an M/Chip and mag stripe application cryptogram with M/Chip data and track 2 data. The mobile wallet application on the user's mobile device next transmits 1214 the cryptogram to the wallet server 112 within a predetermined amount of time. However, if a cryptogram has not been received within the predetermined amount of time, the wallet server then obtains 1216 a cryptogram by either looking up and using the cryptogram stored in an associated database (a static card-on-file (CoF) token) or by retrieving a cryptogram from the DES computer 130 (a cloud token, not shown).

Referring again to FIG. 12A, the wallet server 112 next submits 1218 the cryptogram and a transaction/checkout authorization request to the switch computer 136. Next, the switch computer 136 responds 1220 to the wallet server 112 and also sends 1222 the checkout data to the merchant server 126. The merchant server 126 then generates an authorization request and transmits 1224 it to an acquirer/payment gateway 134 for further processing BAU (via a payment network, not shown). Once the transaction processing is completed, the acquirer/payment gateway 134 sends the authorization response to the merchant server computer 126, which transmits 1226 the authorization result to the merchant terminal 124, which may display 1228 an authorization response message (indicating either authorization of the transaction or denying the transaction), and the process ends. In some implementations, a confirmation (transaction approved/declined) notification message is transmitted to the user's mobile device 104 (not shown), assuming Internet/wireless connectivity exists.

FIG. 12B is a flowchart illustrating a merchant generated QR code process 1250 in accordance with some embodiments. The cardholder utilizes his or her mobile device to launch 1252 a mobile payment application, and in some embodiments the cardholder provides a CVM if requested by the mobile payment application. The cardholder mobile device then receives 1254 a payment card account selection from the cardholder, receives 1256 a “Pay with QR code” selection from the cardholder, and then the cardholder manipulates a camera component of the mobile device to read 1258 a merchant generated QR code. The cardholder's mobile device then transmits 1260 the QR code data to a wallet provider, and in some implementations, receives a value query 1262 (this may occur, for example, if the merchant generated QR code is a static QR code which does not include the value of the transaction, or if a merchant generated barcode has been read by the consumer's mobile device). If a value query is received in step 1262, then a value query is displayed 1264 on the cardholder's mobile device display screen, and if a value is not received 1266 from the user within a predetermined period of time (for example, within 60 seconds) then a transaction failed message is displayed 1268 on the display screen of the consumer's mobile device, and the transaction process ends.

Referring again to FIG. 12B, if the transaction value is received from the user in step 1266 (or if a value query is not received in step 1262) then a transaction confirmation request 1270 is displayed for a response by the user. The transaction confirmation request includes the total amount and currency of the transaction, and may include the merchant name, the selected payment account information (e.g. card image with last 4 digits of the token and/or the actual PAN), the billing address, and a “Confirm” button. As mentioned above, in some implementations the user may also be provided with a “Cancel” button or “Back” button for selection by the consumer. In addition, the transaction confirmation request may include a prompt for the user to provide a CVM (on the same screen or after the user selects the confirm button). If the user does not confirm the transaction in step 1272 within a predetermined period, or selects a Cancel button (if provided) then then a “transaction failed” message is displayed 1268 (or a “transaction canceled” message is displayed) on the display screen of the consumer's mobile device, and the transaction process ends.

However, if the consumer confirms the purchase transaction in step 1272, then the user's mobile device transmits 1274 the confirmation message to a wallet server. Next, if a transaction authorized message is received 1276 within a predetermined period, then a transaction authorized message is displayed 1278, and the transaction process ends. However, if in step 1276 a transaction authorization message is not received within the predetermined amount of time, then a transaction failed message is displayed 1268 on the display screen of the consumer's mobile device, and the transaction process ends.

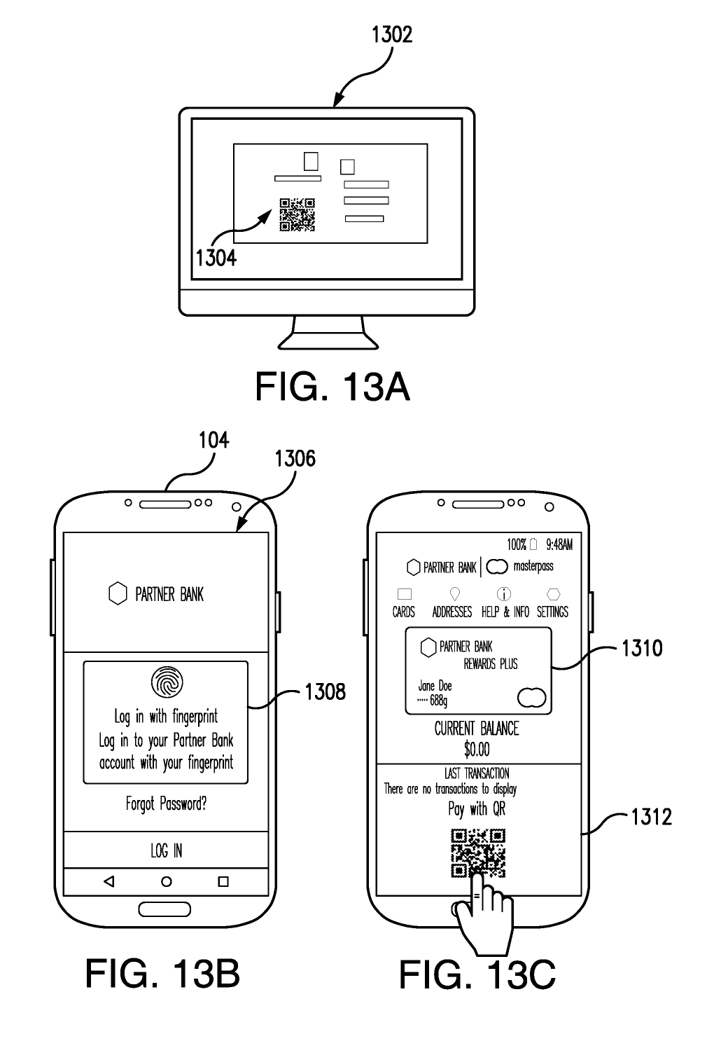

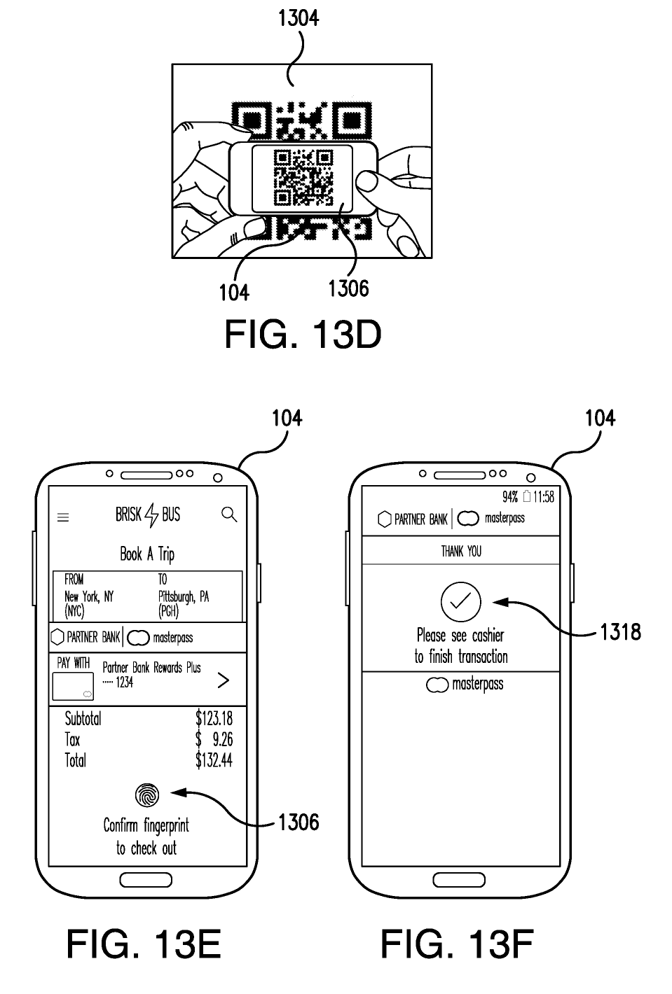

FIGS. 13A-13F illustrate examples of screen displays (or screen shots) of mobile wallet application user interface (UI) screens associated with a digital secure remote payment (DSRP) transaction featuring a merchant generated dynamic QR code process in accordance with some embodiments. FIG. 13A depicts a display screen 1302 which is displaying a merchant-generated, dynamic QR code 1304. The display screen 1302 may be a component of a user's personal computer depicting a merchant's website checkout page, or may be the display screen associated with a merchant's POS terminal in a retail store location, or may be some other merchant device (such as a smartphone) having a display screen component. The merchant-generated dynamic QR code contains the purchase transaction amount (including tax), currency and merchant identification data, and may include other data such as transaction timestamp (time and date of transaction), a nonce (random number), a transaction identifier, merchant location, etc.

FIG. 13B illustrates a user's mobile device 104 or smartphone that includes a display screen 1306 depicting a login page 1308 of a mobile payment application prompting the user to “Log in with fingerprint” to an “issuer mobile wallet.” (As noted above, the processes disclosed herein are not limited to an issuer wallet, as other digital wallets, such as a Masterpass™ direct wallet or a DAC wallet may be utilized.) In some implementations, the user may be prompted to login by using other types of existing application credentials, such as by providing other types of biometric data (such as iris scan data or facial data), or by using a mobile PIN, as may be required by the mobile app. Next, as shown in FIG. 13C, the user selects a payment card account and a representation of the payment card 1310 is displayed along with an option to “Pay with QR” 1312, which is then selected by the user to initiate a QR code payment. Then, as shown in FIG. 13D, the user manipulates his or her mobile device (smartphone) so that the camera component (not shown) is in position to scan or read the merchant generated QR code 1304, which is shown on the display screen 1306 of the user's mobile device 104. Once the QR code is parsed by the user's mobile wallet application, the user is presented with a confirmation screen 1314 as shown in FIG. 13E, which includes a message to “Confirm fingerprint to check out” 1316 (but other CVM methods could be used). After the user reviews the purchase transaction details provided on the display screen, such as the payment card account and total purchase amount, he or she confirms the purchase transaction by providing a fingerprint (or any other consumer CVM data that may be required, such as a mobile PIN, DLA, bank online/mobile banking credentials, mobile application login credentials, biometric data, or the like). Lastly, as shown in FIG. 13F, if the purchase transaction is authorized, the user's mobile device then receives and displays a confirmation message 1318 on the mobile wallet application (on display screen of the consumer mobile device 104), assuming Internet connectivity exists.

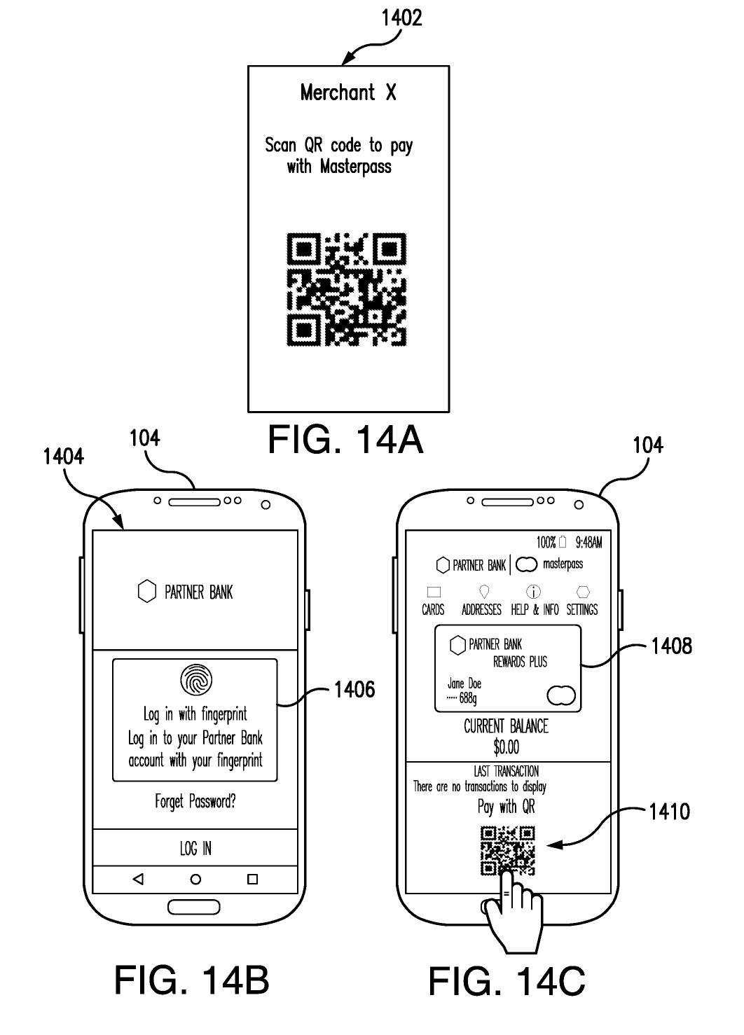

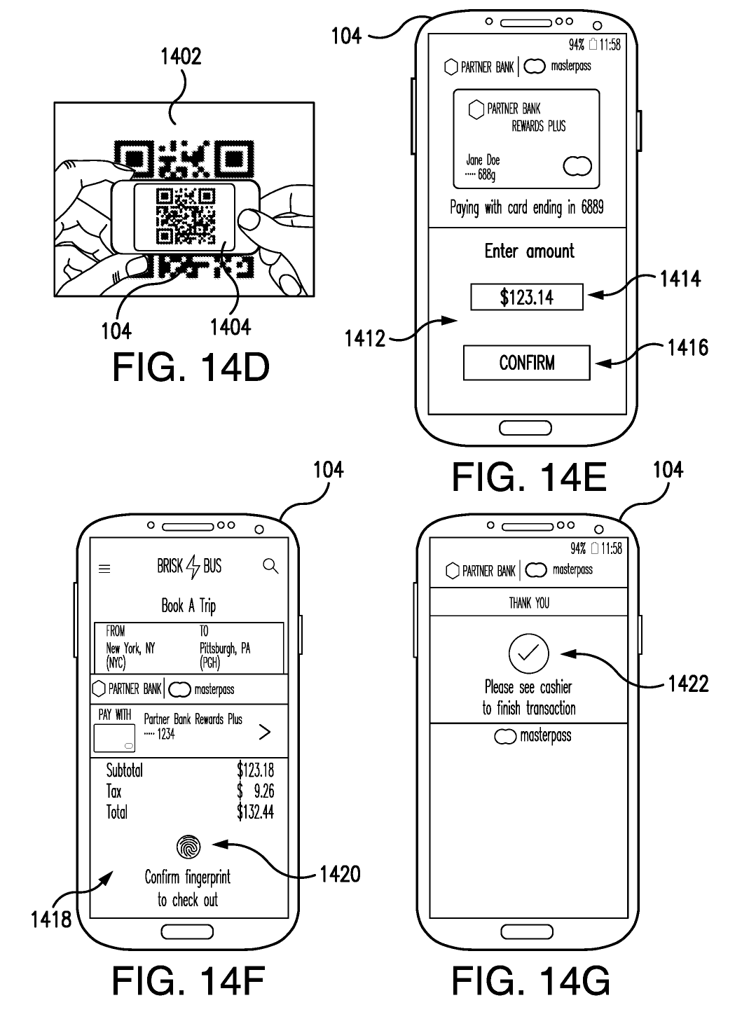

FIGS. 14A-14G illustrate examples of screen displays (or screen shots) of mobile device user interface screens associated with a DSRP transaction featuring a merchant generated static QR code process in accordance with some embodiments. Thus, FIG. 14A depicts a static QR code 1402 being displayed by a merchant. The static QR code 1402 may be displayed, for example, on a sticker or poster/paper attached near or on a merchant's POS terminal in a retail store, or may be displayed on a display screen associated with the merchant's POS terminal in a retail store location, or may be displayed on a display component of some other merchant device (such as a smartphone). The merchant-generated static QR code does not contain the purchase transaction amount, but may include merchant identification data and other static data.

FIG. 14B illustrates a user's mobile device 104 or smartphone that includes a display screen 1404 depicting a login page 1406 of a mobile payment application prompting the user to “Log in with fingerprint” to a “issuer mobile wallet.” (As noted above, the processes disclosed herein are not limited to an issuer wallet, as other digital wallets, such as a Masterpass™ direct wallet or a DAC wallet may be utilized.) In some implementations, the user may be prompted to login by using other types of existing application credentials, such as by providing other types of biometric data (such as iris scan data or facial data), or by using a mobile/wallet PIN, issuer online/mobile banking credentials, mobile wallet application password, as may be required by the mobile payment app. Next, as shown in FIG. 14C, the user selects a payment card account and a representation of the payment card 1408 is displayed along with an option to “Pay with QR” 1410, which is then selected by the user to initiate a QR code payment. Then, as shown in FIG. 14D, the user manipulates his or her mobile device 104 (smartphone) so that the camera component (not shown) is in position to scan or read the merchant generated QR code 1402, which is shown on the display screen 1404 of the user's mobile device 104. Once the QR code is successfully scanned and parsed by the mobile wallet application, as shown in FIG. 14E, the mobile payment application displays a transaction confirmation screen 1412, which prompts the user to enter a purchase transaction value 1414 and then to select a “Confirm” button 1416 to proceed with the purchase transaction. In some implementations, a “Cancel” button (not shown) or “Back” button (not shown) may also be provided for selection by the consumer, which button(s) if selected could be utilized by the user to terminate the transaction process. Also, in some embodiments, depending on the wallet's security configurations and/or CVM model, or if velocity checks failed (e.g. if the user did not provide CVM during login to the payment application (as shown in FIG. 14B) or CVM expired, or if the user made multiple transactions without providing CVM, or if the transaction is for a high value transaction), then a request for the user to provide CVM data (such as providing a mobile/wallet PIN, DLA, and/or biometric data such as iris data, or the like) can be required before proceeding with the purchase transaction.

Referring again to FIG. 14E, after entering the purchase transaction value in field 1414, the user then presses the “Confirm” button 1416 and a confirmation screen 1418 shown in FIG. 14F is displayed, which can include purchase transaction details such as a listing of items and a total transaction value or price, and a message to “Confirm fingerprint to check out” 1420. As explained above, in some implementations, a “Cancel” button (not shown) or “Back” button (not shown) may also be provided for selection by the consumer, which could be used to terminate or end the transaction processing. The user then reviews the purchase transaction details provided on the display screen 1418, and can confirm the purchase transaction by providing a fingerprint (or any other consumer verification method (CVM) data that may be required, such as a mobile PIN, biometric data, or the like) near the message 1420 so that the purchase transaction will be applied to his or her payment card account 1408. Lastly, as shown in FIG. 14G, when the user confirms the purchase transaction and if it is authorized, the mobile wallet application on the user's mobile device then receives and displays a confirmation message 1422 on the display screen of the consumer mobile device 104, assuming that Internet connectivity is available.

The disclosed systems and processes result in the standardization of user interfaces for utilizing QR codes for in-store (M/chip, magstripe and DSRP), in app and online (DSRP) payments. In addition, the owner and/or operator of one or more components for conducting barcode wallet payment transactions benefits from obtaining increased revenues by obtaining digital payments market share from merchants who cannot afford to purchase expensive contactless POS terminals. In addition, implementation of such barcode wallet payments serves to accelerate the deployment and scale of utilizing a switching computer and/or digital enablement system (DES) computer while also increasing payment security due to the use of tokenization by leveraging the DES and/or cloud based payments compliant trusted service provider (TSP). In addition to the security benefits, in some embodiments the processes disclosed herein adhere to global standards for electronically securing payment credentials, and therefore are cost effective because existing payment account infrastructure can be used (such as existing payment card networks), is interoperable and scalable.

Thus, merchants benefit from the disclosed processes because the EMV grade security reduces costs due to reduced merchant fraud which reduces chargebacks, because the consumer is requested to consent to a transaction with a CVM for a Card Present transaction, wherein the transaction amount is displayed to the consumer. Thus, because all of the disclosed purchase transactions are Card Present transactions, the merchant liability is shifted to the issuer, thereby reducing costs related to fraud. In addition, merchants need not purchase expensive POS terminals and can reuse existing legacy systems. As a result, merchants can increase their footprint by supporting digital payments. A payments processing company, such as Mastercard International Incorporated, benefits due to the standardization of QR code payments, an increase in adoption of Masterpass and Mastercard Digital Enablement Services (MDES), and from bolstering their leadership in digital payments while increasing their market share of digital payments. The consumer benefits by being provided with a seamless purchase transaction user experience from any mobile device that has Internet connectivity and a camera, without the need for NFC support. In particular, the user interface is easy to use, available on any device without the need for a host card emulation (HCE) enabled device, and the disclosed payment process is easy, fast and secure.

As used herein and in the appended claims, the term “computer” should be understood to encompass a single computer or two or more computers in communication with each other or a computer network or computer system. In addition, as used herein and in the appended claims, the term “processor” should be understood to encompass a single processor or two or more processors in communication with each other. Moreover, as used herein and in the appended claims, the term “memory” should be understood to encompass a single memory or storage device or two or more memories or storage devices. Such a memory and/or storage device may include any and all types of non-transitory computer-readable media, with the sole exception being a transitory, propagating signal.

The flow charts and descriptions thereof herein should not be understood to prescribe a fixed order of performing the method steps described therein. Rather, the method steps may be performed in any order that is practicable. In addition, the flow charts described herein should not be understood to require that all steps or elements be practiced in every embodiment. For example, one or more elements or steps may be omitted in some embodiments.

Although the present disclosure describes specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method for conducting secure transactions using digital barcodes comprising:
launching, by a consumer mobile device, a mobile payment application;
receiving, by the consumer mobile device via an input component, selection of a payment card account and an instruction to pay via at least one of a quick response (QR) code or a barcode by a cardholder;
generating, by the consumer mobile device, at least one of a dynamic QR code and a barcode;
displaying, by the consumer mobile device, at least one of the dynamic QR code and the barcode on a display component;
receiving, by the consumer mobile device, a purchase transaction confirmation request comprising at least merchant identification data and a transaction amount;
displaying, by the consumer mobile device on the display component, a confirmation notification for approval by the cardholder;
receiving, by the consumer mobile device, a confirmation response from the cardholder; and
transmitting, by the consumer mobile device to a digital enablement system (DES) computer, the confirmation response.

2. The method of claim 1, further comprising:
receiving, by the consumer mobile device, a transaction completed confirmation message; and
displaying, by the consumer mobile device, the transaction completed confirmation message on the display component.

3. The method of claim 2, wherein the transaction completed confirmation message is received via a push notification from one of a payment network via the DES computer, an issuer's remote notification service (RNS), a wallet service provider's RNS, a third party RNS, or a switch computer.

4. The method of claim 1, further comprising, prior to generating at least one of the dynamic QR code and the barcode:
prompting, by the consumer mobile device per the mobile payment application, the cardholder to provide cardholder identification data in accordance with a cardholder verification method (CVM);
receiving, by the consumer mobile device via an input component, cardholder identification data; and
authenticating, by the consumer mobile device, the cardholder identification data.

5. The method of claim 1, wherein the generated dynamic QR code comprises cardholder payment account information, token account information, an M/Chip application cryptogram, M/Chip data, a Mag stripe application cryptogram, and track 2 data.

6. The method of claim 1, wherein the purchase transaction confirmation request further comprises a cancel transaction option for terminating the purchase transaction authorization process.

7. A mobile device configured for conducting secure transactions using digital barcodes comprising:
a mobile device processor;
a display component operably connected to the mobile device processor;
at least one input component operably connected to the mobile device processor; and
a storage device operably connected to the mobile device processor, wherein the storage device comprises a mobile wallet application and instructions configured to cause the mobile device processor to:
launch a mobile payment application;
receive selection of a payment card account and an instruction to pay via at least one of a quick response (QR) code or a barcode via the at least one input component;
generate at least one of a dynamic QR code and a barcode;
display at least one of the dynamic QR code and the barcode on the display component;
receive a purchase transaction confirmation request comprising at least merchant identification data and a transaction amount;
display a confirmation notification on the display component for approval by the cardholder;
receive a confirmation response via the at least one input component from the cardholder; and
transmit the confirmation response to a digital enablement system (DES) computer.

8. The apparatus of claim 7, wherein the storage device comprises further instructions configured to cause the mobile device processor to:
receive a transaction completed confirmation message; and
display the transaction completed confirmation message on the display component.

9. The apparatus of claim 8, wherein the transaction completed confirmation message is received via a push notification from one of a payment network via the DES computer, an issuer's remote notification service (RNS), a wallet service provider's RNS, a third party RNS, or a switch computer.

10. The apparatus of claim 7, wherein the storage device further comprises, prior to the instructions for generating at least one of the dynamic QR code or the barcode, instructions configured to cause the mobile device processor to:
prompt, per the mobile wallet application, the cardholder to provide cardholder identification data in accordance with a cardholder verification method (CVM);
receive, via the at least one input component, cardholder identification data; and
authenticate the cardholder identification data.

11. The apparatus of claim 7, wherein the generated dynamic QR code comprises cardholder payment account information, token account information, an M/Chip application cryptogram, M/Chip data, a Mag stripe application cryptogram, and track 2 data.

12. The apparatus of claim 7, wherein the purchase transaction confirmation request further comprises a cancel transaction option for terminating the purchase transaction authorization process.

13. A method for conducting secure transactions using a quick response (QR) code comprising:
launching, by a consumer mobile device, a mobile payment application;
receiving, by the consumer mobile device via an input component, selection of a payment card account and an instruction to pay via quick response (QR) code by a cardholder;
reading, by a camera component of the consumer mobile device, a QR code of a merchant;
parsing, by the consumer mobile device, the QR code to obtain QR code data;
generating, by the consumer mobile device, a cryptogram;
transmitting, by the consumer mobile device, the QR code data and the cryptogram to a wallet server computer;
receiving, by the consumer mobile device, a purchase transaction confirmation request comprising at least merchant identification data and a transaction amount;
displaying, by the consumer mobile device on a display component, a confirmation notification for approval by the cardholder;
receiving, by the consumer mobile device, a confirmation response from the cardholder; and
transmitting, by the consumer mobile device to a wallet provider computer, the confirmation response.

14. The method of claim 13, further comprising:
receiving, by the consumer mobile device, a purchase transaction confirmation message; and
displaying, by the consumer mobile device on the display component, the purchase transaction confirmation message.

15. The method of claim 13, further comprising, prior to generating the cryptogram,
determining, by the consumer mobile device, that the transaction amount is missing from the QR code data;
prompting, by the consumer mobile device, the cardholder to confirm the transaction; and
receiving, by the consumer mobile device, a confirmation indication from the cardholder.

16. The method of claim 15, wherein receiving the confirmation indication further comprises:
receiving cardholder verification method (CVM) data; and
verifying, by the consumer mobile device, the CVM data.

17. A mobile device configured for conducting secure transactions using quick response (QR) codes comprising:
a mobile device processor;
a display component operably connected to the mobile device processor;
a camera component operably connected to the mobile device processor;
at least one input component operably connected to the mobile device processor; and
a storage device operably connected to the mobile device processor, wherein the storage device comprises a mobile wallet application and instructions configured to cause the mobile device processor to:
launch a mobile payment application;
receive selection of a payment card account and an instruction to pay via quick response (QR) code via the at least one an input component from a cardholder;
read, by the camera component, a QR code of a merchant;
parse the QR code to obtain QR code data;
generate a cryptogram;
transmit the QR code data and the cryptogram to a wallet server computer;
receive a purchase transaction confirmation request comprising at least merchant identification data and a transaction amount;
display a confirmation notification on the display component for approval by the cardholder;
receive a confirmation response via the at least one input component from the cardholder; and
transmit the confirmation response to a wallet provider computer.

18. The apparatus of claim 17, wherein the storage device comprises further instructions configured to cause the mobile device processor to:
receive a purchase transaction confirmation message; and
display the purchase transaction confirmation message on the display component.

19. The apparatus of claim 17, further comprising, prior to the instructions for generating the cryptogram, instructions configured to cause the mobile device processor to:
determine that the transaction amount is missing from the QR code data;
prompt the cardholder to confirm the transaction; and
receive a confirmation indication via the at least one input component from the cardholder.

20. The apparatus of claim 19, wherein the instructions for receiving the confirmation indication further comprises instructions configured to cause the mobile device processor to:
receive cardholder verification method (CVM) data; and
verify the CVM data.
